(19) United States
(12) Patent Application Publication
(10) Pub. No.: US 2007/0227509 A1
(43) Pub. Date: Oct. 4, 2007

(54) Internal combustion engine having improved fuel pump configuration, and vehicle including same

(75) Inventors: Hiroya Ueda, Saitama (JP); Katsunori Takahashi, Saitama (JP); Katsuhiro Kunikiyo, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/728,825

(22) Filed: Mar. 27, 2007

(30) Foreign Application Priority Data
Mar. 31, 2006 (JP) 2006-100782

(51) Int. Cl. F02M 37/04; F01L 1/02; F02M 51/00

(52) U.S. Cl. 123/509; 123/90.27; 123/472

(57) ABSTRACT

An engine-mounted mechanical fuel pump for an internal combustion engine contributes to a stable operation of the engine, a reduction in the weight of the engine, and a reduction in the pump drive loss. The engine includes a cylinder head provided with intake ports and exhaust ports therein, and fuel injection valves for injecting fuel into the inside of a tubular intake air routing assembly connected to the intake ports. A fuel pump is provided on the rear side of a cylinder block and on the upper side of a crankcase, in an arrangement where the intake ports are formed to extend rearwardly and the exhaust ports are formed to extend forwardly from the cylinder head. In one embodiment, the fuel pump is provided on the front side of the cylinder block, where the intake ports are formed to extend forwardly and the exhaust ports are formed to extend rearwardly.

### CROSS-REFERENCE TO RELATED APPLICATIONS

The present invention claims priority under 35 USC 119 based on Japanese patent application No. 2006-100782, filed on Mar. 31, 2006. The subject matter of this priority document is incorporated by reference herein.

### BACKGROUND OF THE INVENTION

1. Field of the Invention

The present invention relates to an internal combustion engine provided with a fuel pump, and to a vehicle including same. The fuel pump supplies fuel to a fuel injector, which in turn injects the fuel into an intake air routing assembly of the engine. More particularly, the present invention relates to an engine having an improved fuel pump configuration and location, and to a vehicle incorporating the engine and fuel pump.

2. Description of the Background Art

Known vehicular fuel delivery systems exist in which a fuel pump is provided for delivering fuel from a fuel tank to an engine, and a fuel metering device, such as a carburetor, an injector, etc. is provided on an engine for injecting the fuel into the inside of an intake air routing assembly. Such an engine configuration is disclosed, for example, Japanese Patent Laid-open No. Sho 57-113953.

In the known system of the above reference, the intake air routing assembly is connected to an intake port that communicates with a combustion chamber. In order to supply fuel into the combustion chamber, there is a conventional technique in which a discharge port of the fuel pump and a suction port of the fuel injector are connected to each other through a pipe. In this case, the fuel pump is a mechanically driven type pump, which is driven by the internal combustion engine.

According to Japanese Patent Laid-open No. Sho 57-113953, an intake port is formed to extend rearwardly from a combustion chamber, and an intake air routing assembly, in connection with an air cleaner chamber, is provided so as to extend rearwardly from a rear portion of a cylinder head. In addition, an exhaust port is formed to extend forwardly from the combustion chamber, and an exhaust pipe is provided to extend downwardly from a front portion of the cylinder head. Further, a fuel pump is provided at a front portion of the cylinder head, and a carburetor is interposed in the intake air routing assembly.

Meanwhile, since a combustion gas is introduced into the exhaust pipe, the exhaust pipe itself is brought to a high temperature when the internal combustion engine is operated. According to the conventional configuration, the fuel pump is provided in the vicinity of the exhaust pipe. As a result of exposure to radiant heat generated by the exhaust pipe, problems such as percolation may arise in the fuel pump. In order to avoid these problems, it is preferable that the fuel pump is provided at a position where the fuel pump would not easily be thermally influenced in this manner.

In addition, since the intake air routing assembly is connected to a rear portion of the cylinder head, the pipe connecting the fuel pump and the carburetor to each other is relatively long. This leads to an increase in the weight of the internal combustion engine, and to a pressure loss during the process of supplying the fuel from the fuel pump to the carburetor, possibly resulting in a loss of drive of the fuel pump.

In consideration of the above-described problems, it is an object of the present invention to provide a fuel pump for an internal combustion engine in which the weight of the internal combustion engine is reduced and the pump drive loss is also reduced.

### SUMMARY

In order to attain the above object, according to a first aspect of the present invention, there is provided a fuel pump for an internal combustion engine. The engine includes a cylinder block having a cylinder chamber in which a piston is reciprocally slidably disposed. A cylinder head is disposed on the upper side of, and is connected to, the cylinder block so as to cover the cylinder chamber. The cylinder head is provided therein with an intake port that extends rearward and an exhaust port that extends forward, and the intake port and the exhaust port are in communication with a combustion chamber. A crankcase is provided on the lower side of, and is connected to, the cylinder block. The crankcase extends rearward and is provided therein with a crank chamber rotatably containing a crankshaft connected to the piston. An intake air routing assembly is connected to the intake port, and a fuel injector is provided on the intake air routing assembly and injects fuel into the inside of the intake air routing assembly. The fuel pump is a mechanically driven type fuel pump that supplies fuel to the fuel injector, and the fuel pump is provided on the rear side of the cylinder block and on the upper side of the crankcase.

In this instance, a camshaft is rotatably supported on the cylinder head. A cam drive mechanism is contained in an endless power transmission belt chamber formed inside lateral portions of the cylinder block and the cylinder head, the cam drive mechanism transmitting the rotation of the crankshaft to the camshaft. A pump drive mechanism for transmitting the rotation from the crankshaft to a drive shaft of the fuel pump is also provided. One end of the crankshaft projects outside of the crankcase, and a drive element of the cam drive mechanism is provided at the one end part. The pump drive mechanism includes a pump drive sprocket that is provided at the one end part of the crankshaft, and is located on the axially inner side relative to the drive element of the cam drive mechanism. In addition, a pump driven sprocket is provided on the drive shaft of the fuel pump, and a pump endless power transmission belt is wrapped around the pump drive sprocket and the pump driven sprocket.

In a further aspect of the invention, a camshaft is rotatably supported on the cylinder head, and a cam drive mechanism is contained in an endless power transmission belt chamber formed inside lateral portions of the cylinder block and the cylinder head, the cam drive mechanism transmitting the rotation of the crankshaft to the camshaft. A pump drive mechanism for transmitting the rotation from the crankshaft to a drive shaft of the fuel pump is provided. The cam drive mechanism includes a cam drive sprocket provided on the crankshaft, a cam driven sprocket provided on the camshaft, and a cam endless power transmission belt that is wrapped around the cam drive sprocket and the cam driven sprocket. In this case, the pump drive mechanism picks up a driving force from a pump sprocket driven by the cam endless power transmission belt.

Moreover, in a further aspect of the invention, a cam is formed integrally with the outer periphery of a web of the crankshaft, and a pump drive mechanism is provided for transmitting the rotation of the crankshaft to the fuel pump to thereby drive the fuel pump. In this case, the pump drive mechanism includes a rod abutting on the cam and extending in a direction orthogonal to the axis of the crankshaft.

In addition, in a yet further aspect of the invention, a power transmission device is provided for transmitting the rotation of the crankshaft to a wheel or wheels, and a pump drive mechanism is provided for transmitting the rotation from the crankshaft to a drive shaft of the fuel pump. The power transmission device includes a main shaft disposed in parallel to the crankshaft, a primary speed reduction transmission path that transmits the rotation of the crankshaft to the main shaft through speed reduction, and a clutch mechanism provided at the main shaft so as to connect and disconnect the primary speed reduction transmission path. The primary speed reduction transmission path includes a primary speed reduction drive element connected to the crankshaft, and a primary speed reduction driven element rotated with a speed reduction relative to the primary speed reduction drive element, provided rotatably relative to the main shaft and connected to an upstream-side member of the clutch mechanism. In this case, the pump drive mechanism includes a pump drive sprocket provided to be rotatable integrally with the primary speed reduction driven element, a pump driven sprocket provided on the drive shaft of the fuel pump, and a pump endless power transmission belt wrapped around the pump drive sprocket and the pump driven sprocket.

Furthermore, according to another aspect of the present invention, there is provided a fuel pump for an internal combustion engine connected to a frame of a vehicle and mounted on the vehicle. Specifically, this aspect of the invention pertains to a mechanically driven type fuel pump for supplying fuel to a fuel injection valve in an internal combustion engine. The engine includes a cylinder block provided therein with a cylinder chamber in which a piston is slidably disposed. The cylinder block is exposed from the frame relative to the vehicle, with the axis of the cylinder chamber inclined toward the front side of the vehicle. A cylinder head is connected to the cylinder block so as to cover the cylinder chamber, and is exposed from the frame relative to the vehicle. An intake port and exhaust port are provided in the cylinder head, the intake port extending upwards and the exhaust port extending forward therefrom. The intake port and the exhaust port are in communication with a combustion chamber. A crankcase is provided on the rear side of, and is connected to the cylinder block. A crank chamber is formed within the crankcase, a crankshaft is rotatably supported therein, and the crankshaft is connected to the piston. A tubular intake air routing assembly is connected to the intake port. The fuel injection valve is provided at the intake air routing assembly and injects fuel into the inside of the intake air routing assembly. The fuel pump is provided on the upper side of the cylinder head.

In this instance, where a camshaft is rotatably supported on the cylinder head, and a pump drive mechanism is provided for rotating the rotation from the crankshaft to a drive shaft of the fuel pump, the pump drive mechanism includes a pump drive gear provided on the camshaft, and a pump driven gear provided on the drive shaft of the fuel pump in the state of being meshed with the pump drive gear.

Furthermore, according to yet another aspect invention of the present invention, there is provided a fuel pump for an internal combustion engine. The engine includes a cylinder block provided therein with a cylinder chamber. A cylinder head is provided on the upper side of, and connected to, the cylinder block so as to cover the cylinder chamber. The cylinder head is provided therein with an intake port and an exhaust port, which communicate with a combustion chamber. An intake air routing assembly is connected to the intake port. The intake port is formed to extend inside the cylinder head forward from the combustion chamber, whereas the exhaust port is formed to extend inside the cylinder head rearward from the combustion chamber. A fuel injection valve is provided at the intake air routing assembly and injects fuel into the inside of the intake air routing assembly. The fuel pump is a mechanically driven type internal-combustion-engine fuel pump for supplying the fuel to the fuel injection valve. The fuel pump is provided on the front side of the cylinder block and on the lower side of the intake gas pipe member.

According to the fuel pump for an internal combustion engine pertaining to the first aspect of the present invention configured as above-described, the fuel pump is provided at a position spaced from the exhaust pipe, so that the thermal influence on the fuel pump is reduced, and more simple heat insulation structure for the fuel pump can be contrived. In addition, since the fuel pump is provided near the fuel injector, the pipe for connection between the fuel pump and the fuel injector is shortened, and the pump drive loss is reduced. This makes it possible to reduce the fuel pump in size and to reduce the overall weight of the internal combustion engine.

In the case where the cam drive mechanism is contained in the endless power transmission belt chamber and the drive element of the cam drive mechanism is provided at the crankshaft, the cylinder block must be provided therein with a wall for partitioning the endless power transmission belt chamber and the cylinder chamber from each other. Therefore, the drive element of the cam drive mechanism must be disposed with an offset to the axially outer side by an amount corresponding to the space secured for forming the inside wall, resulting in the formation of a dead space on the axially inner side of the drive element of the cam drive mechanism, over the crankshaft. In the above-described configuration, the drive sprocket of the pump drive mechanism is provided in the dead space. Therefore, in configuring the pump drive mechanism for picking up power directly from the crankshaft, the pump drive mechanism can be provided without enlarging the crankshaft in size along the axial direction.

In addition, in the case where the cam drive mechanism is contained in the inside of the endless power transmission belt chamber, the cam drive mechanism includes the cam endless power transmission body, and the pump drive mechanism includes the pump sprocket driven by the cam endless power transmission body, a rotating member already provided in the internal combustion engine can be utilized as a drive element of the pump drive mechanism, which makes it possible to reduce the number of component parts for exclusive use in the pump drive mechanism, and to reduce the overall weight of the internal combustion engine. The rotating speed of the crankshaft varies according to the operating condition of the internal combustion engine, and the variations in rotation are exerted also on the endless power transmission body. Thus, the endless power transmission body must have endurance performance for stably operating against the variations in rotation. In the present configuration, the variations in rotation of the endless power transmission belt are attenuated, by using drive friction of the fuel pump, whereby enhanced endurance performance of the endless power transmission belt is obtained.

In addition, in the case where the cam is provided on the web of the crankshaft and the pump drive mechanism includes the rod abutting on the cam, also, the pump drive mechanism can be configured by utilizing a rotating member already provided in the internal combustion engine, so that the number of component parts for exclusive use in the pump drive mechanism are reduced, and the overall weight of the internal combustion engine is also reduced.

In addition, in the case where the pump drive sprocket rotates as one body with the primary speed reduction driven element of the power transmission device, a driving force with speed reduction relative to the crankshaft can be transmitted, the fuel pump can thereby be driven at a lower rotating speed, and, therefore, a reduction in the pump drive loss is obtained. In addition, since the pump mechanism is so configured as to pick up power with speed reduction, it is unnecessary to attain a large speed reduction in the pump drive mechanism, so that it is possible to reduce the diameter of the pump drive sprocket and to reduce the area occupied by the pump endless power transmission belt.

Further, in the fuel pump for an internal combustion engine in another aspect of the invention, the fuel pump is provided at a position spaced from the exhaust pipe and near the fuel injector, so that a more simple heat insulation structure for the fuel pump can be used, and a reduction in the pump drive loss is obtained. Furthermore, the cylinder block is mounted on the vehicle with the axis of the cylinder chamber inclined toward the front side, the cylinder block and the cylinder head are provided to be exposed from the frame, and the fuel pump is provided on the upper side (the front side, in the forwardly inclined posture) of the cylinder head. Therefore, the fuel pump is air-cooled due to the collision of the running airflow on the fuel pump during running of the vehicle, whereby the operating performance of the fuel pump is enhanced.

In this instance, the pump drive mechanism is configured by providing the drive gear on the camshaft provided in the cylinder head, whereby the fuel pump is provided closer to the camshaft, as compared with the chain power transmission system. As a result, an increase in the vertical length (the front-rear length, in the forwardly inclined posture) of the internal combustion engine can be avoided. In addition, where the pump drive mechanism is of the chain power transmission system, the camshaft, the pump drive mechanism and the fuel pump must be mounted at the same time. In the present configuration, on the other hand, the fuel pump provided with the driven gear can be mounted after the camshaft provided with the drive gear is mounted, whereby ease of assembly is enhanced.

Furthermore, in the fuel pump for an internal combustion engine according to still another aspect of the present invention, also, the fuel pump is provided at a position spaced from the exhaust pipe and near the fuel injector, so that a more simple heat insulation structure for the fuel pump can be used, and a reduction in the pump drive loss is obtained. In addition, since the fuel pump is provided on the front side of the cylinder head and on the lower side of the intake gas routing pipe, the fuel pump is air-cooled during running of the vehicle, whereby the operating performance of the fuel pump can be enhanced.

Modes for carrying out the present invention are explained below by reference to an embodiment of the present invention shown in the attached drawings. The above-mentioned object, other objects, characteristics and advantages of the present invention will become apparent form the detailed description of the embodiment of the invention presented below in conjunction with the attached drawings.

### BRIEF DESCRIPTION OF THE DRAWINGS

FIG. 1 is a left side plan view of a motorcycle on which is mounted an internal combustion engine provided with a fuel pump that supplies fuel thereto according to the present invention.

FIG. 2 is a right side sectional view of the engine of FIG. 1, showing the fuel pump disposed on a side of the cylinder head that is opposed to the exhaust pipe.

FIG. 3 is a sectional view of the engine of FIG. 1, showing the cylinder head and cylinder block.

FIG. 4 is a sectional view of the engine of FIG. 1, showing the transmission.

FIG. 5 is a sectional view of the engine of FIG. 1, showing the starter motor relative to the crankshaft and main shaft.

FIG. 6 is an enlarged view of a portion of the motorcycle of FIG. 1, showing the mounting relationship of an air cleaner chamber and a fuel tank.

FIG. 7 is a block diagram of a fuel supply system of the engine of FIG. 1.

FIG. 8 is an enlarged sectional view of a portion of the engine of FIG. 1, showing the structure of the fuel pump according to a first embodiment.

FIG. 9 is a right side sectional view of an engine showing a fuel pump arrangement according to a second embodiment of the invention.

FIG. 10 is a left side sectional view of an engine showing a fuel pump arrangement according to a third embodiment of the invention.

FIG. 11 is a sectional view of a portion of the engine of FIG. 10 showing the structure of the fuel pump according to the third embodiment.

FIG. 12 is a sectional view of an engine showing a fuel pump arrangement according to a fourth embodiment of the invention.

FIG. 13 is a right side sectional view of a portion of the engine of FIG. 12 showing the structure of the fuel pump according to the fourth embodiment.

FIG. 14 is a right side sectional view of an engine showing a fuel pump arrangement according to a fifth embodiment of the invention.

FIG. 15 is a sectional view of a portion of the engine of FIG. 14 showing the structure of the fuel pump according to the fifth embodiment.

FIG. 16 is a sectional view of a portion of an engine showing the structure of a fuel pump according to a sixth embodiment.

FIG. 17 is a right side sectional view of an engine showing a fuel pump according to a seventh embodiment.

FIG. 18 is a right side sectional view of an engine showing a fuel pump according to a modified embodiment of the seventh embodiment.

### DETAILED DESCRIPTION

A selected illustrative embodiment of the invention will now be described in some detail, with reference to the drawings. It should be understood that only structures considered necessary for clarifying the present invention are described herein. Other conventional structures, and those of ancillary and auxiliary components of the system, are assumed to be known and understood by those skilled in the art. In the drawings, the direction indicated by arrow U is the upward direction, the direction indicated by arrow F is the forward direction, and these directions indicated by arrows correspond to the directions as viewed from the driver of a vehicle. Moreover, references to the left or right are made with respect to the corresponding lateral sides of the vehicle as viewed by the driver of the vehicle.

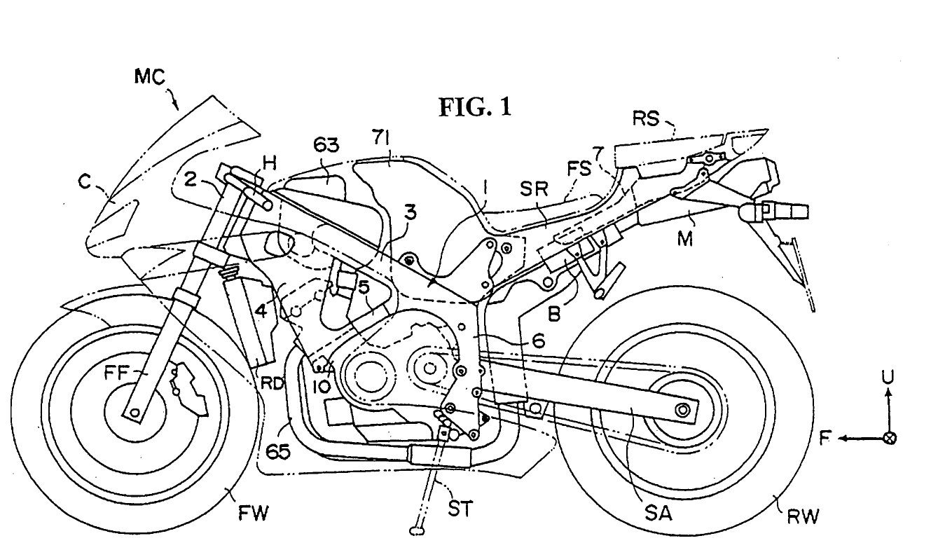

FIG. 1 shows a motorcycle MC on which an internal combustion engine 10 is mounted. The engine 10 is provided with a fuel pump according to the present invention. The motorcycle MC is a full-cowling type vehicle including a vehicle body frame 1 formed from an aluminum alloy. The engine 10 is suspended from the vehicle body frame as a frame member. The motorcycle MC also includes a front fork FF mounted to a head pipe 2 of the vehicle body frame 1, a front wheel FW mounted to the front fork FF, a steering handle H connected to the front fork FF, seat rails SR extending rearward from the vehicle body frame 1, and a front seat FS and a rear seat RS attached to the seat rails SR. In addition, the motorcycle MC includes a swing arm SA of which a front end portion is pivotally connected to pivot brackets 6 of the vehicle body frame 1, a rear wheel RW mounted to rear end portions of the swing arm SA, an air cleaner chamber 63 and a fuel tank 71 mounted to upper portions of the vehicle body frame 1, and a muffler M connected to an exhaust pipe 65 attached to the engine 10, as main component members. The vehicle body, composed of the vehicle body frame 1 and the seat rails SR, is covered with a cowl C indicated by imaginary lines.

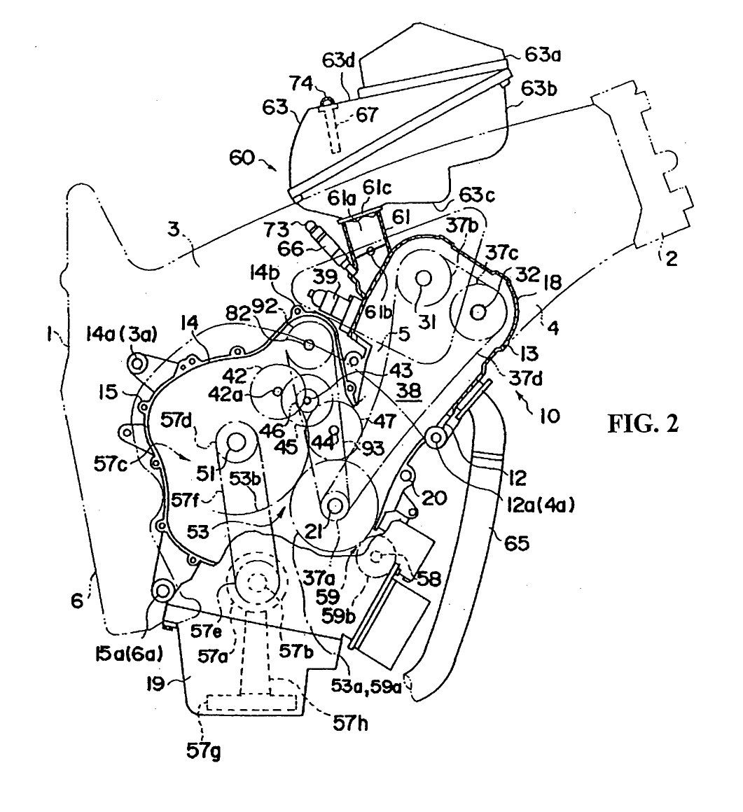

As also shown in FIG. 2, the vehicle body frame 1 has a twin tube structure including a head pipe 2 located at a front end portion thereof, a pair of main frames 3 branched from the head pipe 2 to the left and right sides and extending rearward, and a left-right pair of hangers 4 extending rearwardly downwards from front end portions of the main frames 3. The vehicle body frame 1 also includes a left-right pair of reinforcement frames 5 extending rearwardly upwards from lower end portions of the hangers 4 and connected to central portions in the front-rear direction of the main frames 3, a left-right pair of the pivot brackets 6 which extend downwardly from rear end portions of the main frames 3 and to which a front end portion of the swing arm SA is pivotally connected, and three cross pipes (not shown) bridgingly provided between rear upper end portions of the main frames 3, between upper end portions of the pivot brackets 6, and between lower end portions of the pivot brackets 6.

In addition, the exhaust pipe 65 is a metallic pipe which extends downwards from the front side of the engine 10, curves to extend toward the rear side of the vehicle body frame 1, curves again to extend from the rear end of the vehicle body frame 1 upwards along the pivot brackets 6, and extends further from the upper ends of the pivot brackets 6 along the seat rails SR to the muffler M. Incidentally, on the upper side of the muffler M, a heat insulating plate 7 is provided so as to cover the muffler M. In addition, a radiator RD is provided on the front side of the engine 10, and a battery B is attached to the seat rails SR. A stand ST is pivotally mounted to lower end portions of the pivot brackets 6.

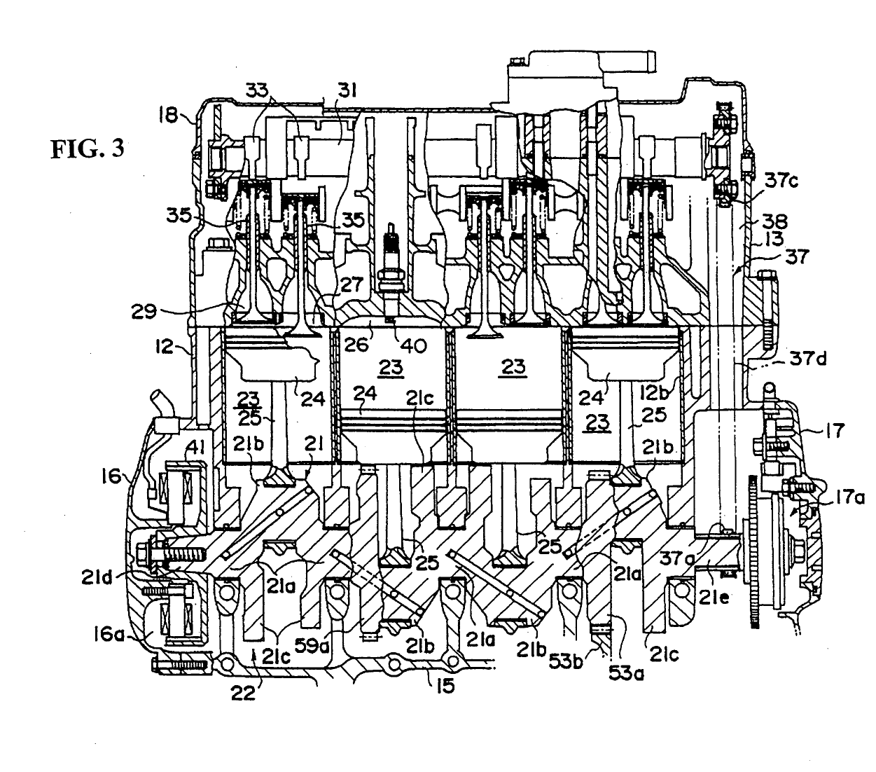

FIGS. 2 to 8 illustrate aspects of the engine 10 provided with a fuel pump 80 according to a first embodiment of the invention. Connection holes 3a, 4a, 6a are formed in rear end portions of the main frames 3. The engine 10 is suspended from the vehicle body frame 1 in the state of being fastened to the connection holes 3a, 4a, 6a, lower end portions of the hangers 4, and lower end portions of the pivot brackets 6, respectively. The engine 10 is contained in an inside space of the vehicle body frame 1 surrounded by the frame elements, and is mounted on a central portion in the front-rear direction and the left-right direction and a lower portion, of the motorcycle MC.

The engine 10 is a 4-stroke parallel 4-cylinder reciprocating engine, which includes a crankcase 20, a cylinder block 12 and a cylinder head 13, arranged in this order from the lower side thereof. In describing the parallel 4-cylinder engine 10 hereinafter, in order to specify the positions of the members (cylinder bores, pistons, crank pins, journals, etc.) arrayed in the left-right direction, they may sometimes be referred to by use of the terms of first, second, and so on, corresponding to the order of the member from the left side. For example, journals 21a may refer to a first journal, a second journal, . . . , and a fifth journal, with respect to the order of the journal from the left side.

The crankcase 20 has an upper-lower split structure formed by coupling an upper case half 14 and a lower case half 15. In addition, the upper case half 14 of the crankcase 20 and the cylinder block 12 are formed as one body, to provide a large-type upper case 11.

A crankshaft 21 is rotatably supported on the respective confronting surfaces of the upper case half 14 and lower case half 15, hereafter referred to as the split surfaces of the case halves 14, 15. The crankshaft 21 has five journals 21a, . . . , 21a, and each crank pin 21b is formed between the adjacent journals 21a, . . . , 21a. Thus, the crankshaft 21 is provided with four crank pins 21b, and crank webs 21c, 21c are formed at the left and right ends of each crank pin 21b. The lower end surface of the upper case half 14 and the upper end surface of the lower case half 15 are provided with support portions for rotatably supporting the journals 21a, . . . , 21a. The crankshaft 21 is contained in a crank chamber 22 formed inside the crankcase 20.

A left cover 16 is mounted so as to cover the left side surface of the crankcase 20, and a left accessory chamber 16a is formed in the inside of the left cover 16. In addition, a right cover 17 is mounted so as to cover the right side surface of the crankcase 20, and a right accessory chamber 17a is formed in the inside of the right cover 17. The support portion for supporting the first journal 21a is formed at the left side surface of the crankcase 20, and a left end portion 21d of the crankshaft 21 protrudes from the left side surface of the crankcase 20, and is contained in the left accessory chamber 16a. A generator 41, which is driven by the crankshaft 21, is mounted to the left end portion 21d. Similarly, the support portion for supporting the fifth journal 21a is formed at the right side surface of the crankcase 20, and a right end portion 21e of the crankshaft 21 protrudes from the right side surface of the crankcase 20, and is contained in the right accessory chamber 17a.

In the inside of the cylinder block 12, cylinder bores 23, which communicate with the crank chamber 22, are formed in the state of being arrayed side-by-side in the left-right direction and opened to the upper and lower sides. Pistons 24 are inserted respectively in the cylinder bores 23 and the pistons 24 are reciprocally slidable in the cylinder axial direction inside the corresponding cylinder bores. In addition, in the inside of the cylinder block 12, a water jacket 12b is formed to surround the four cylinder bores 23. Cooling water discharged from a water pump (not shown) is introduced into the water jacket 12b.

The pistons 24 are connected to the crank pins 21b through connecting rods 25, and the reciprocating motions of the pistons 24 are interlocked with the rotation of the crankshaft 21. In addition, the four pistons reciprocate in a phase relationship such that the first and fourth pistons 24 are located at their top dead centers when the second and third pistons are located at their bottom dead centers.

A front upper end portion of the cylinder block 12, a rear lower end portion of the upper case half 14, and a rear lower end portion of the lower case half 15 are provided with bolt holes 12a, 14a, and 15a, respectively. The bolt hole 12a in the cylinder block 12 is aligned with the connection holes 4a in the hangers 4, the bolt hole 14a in the upper case half 14 is aligned with the connection holes 3a in the main frames 3, and the bolt hole 15a in the lower case half 15 is aligned with the connection holes 6a in the pivot brackets 6. When fastened to the vehicle body frame 1 by aligning these bolt holes 12a, 14a and 15a with the connection holes 3a, 4a and 6a, the engine 10 is mounted on the motorcycle MC in the condition where the axes of the cylinder bores 23 are slightly inclined forward along the direction in which the hangers 4 extend and the cylinder head 13 is disposed between the left-right pair of hangers 4.

The cylinder head 13 is disposed on the upper side of and in connection with the cylinder block 12 so as to cover the upper side of the cylinder bores 23. This ensures that four combustion chambers 26 are each formed in the state of being surrounded by the inner peripheral surface defined by the cylinder bore 23, the piston 24 and the cylinder head 13. Spark plugs 40 are each mounted to the cylinder head 13, with its electrode portion fronting on a central portion of the combustion chamber 26. In addition, the cylinder head 13 is provided therein with intake ports 29 communicating with the combustion chambers 26 through intake openings 27, and exhaust ports 30 communicating with the combustion chambers 26 through exhaust openings 28.

In addition, a head cover 18 is connected to the cylinder head 13 so as to cover the upper side of the cylinder head 13. The intake openings 27 and the exhaust openings 28 are opened and closed respectively with intake valves 35 and exhaust valves 36 mounted to the cylinder head 13. An intake camshaft 31 and an exhaust camshaft 32, aligned in a front-rear relationship in which the intake camshaft 31 is provided on the rear side, are rotatably supported on the split surfaces of the cylinder head 13 and the head cover 18, and extend in the left-right direction. The intake camshaft 31 is provided with cams 33 abutting on the upper ends of the intake valves 35, and the exhaust camshaft 32 is provided with cams 34 abutting on the upper ends of the exhaust valves 36. When both the camshafts 31, 32 are rotated, the cams 33, 34 act to push down the valves 35, 36 against urging forces of valve springs, whereby the normally-closed intake openings 27 and the exhaust openings 28 are opened.

In addition, both the camshafts 31, 32 are rotated through the transmission of the rotation of the crankshaft 21 to a cam drive mechanism 37. The cam drive mechanism 37 includes a cam drive sprocket 37a connected to a right end portion of the crankshaft 21, a first cam driven sprocket 37b connected to the intake camshaft 31, a second cam driven sprocket 37c connected to the exhaust camshaft 32, and a cam chain 37d wrapped around the three sprockets 37a to 37c. The cam drive mechanism 37 transmits the rotation of the crankshaft 21 to both the camshafts 31, 32 while reducing the rotating speed to one half. It is understood that the member wrapped around the sprockets is not limited to the chain; for example, a belt may also be used.

On the right side in the interiors of the cylinder block 12 and the cylinder head 13, a chain chamber 38, which communicates with the right accessory chamber 17a, extends vertically on the right side of the water jacket 12b. The cam chain 37d is contained in the chain chamber 38. In order to form the chain chamber 38 on the right side in the interior of the cylinder block 12, the chain chamber 38 must be formed on the right side of the water jacket 12b; therefore, the cam drive sprocket 37a disposed at a right end portion 21e of the crankshaft 21 must be located with an offset to the right side by an amount corresponding to a space necessary for partitioning the fourth cylinder bore 23, the water jacket 12b and the chain chamber 38 from the fifth journal 21a in the left-right direction.

A chain tensioner 39 externally exerts a pressing force on the cam chain 37d so that the cam chain 37d operates without slack, and is provided at a rear upper portion of the cylinder block 12. In order to accommodate the chain tensioner 39, a rear upper end portion of the cylinder block 12 and a rear lower end portion of the cylinder head 13 are formed in the state of projecting to the rear side. The cam chain 37d is pressed from the rear outer side by utilizing the chain tensioner 39.

The intake port 29 is formed to extend from the intake opening 27 toward the rear side of the cylinder head 13, and opens at a rear portion of the cylinder head 13. An intake air routing assembly 60 (described later) is connected to this opening of the intake port 29. The exhaust port 30 is formed to extend from the exhaust opening 28 toward the front side of the cylinder head 13, and opens at a front portion of the cylinder head 13. The above-mentioned exhaust pipe 65 is connected to this opening of the exhaust port 30.

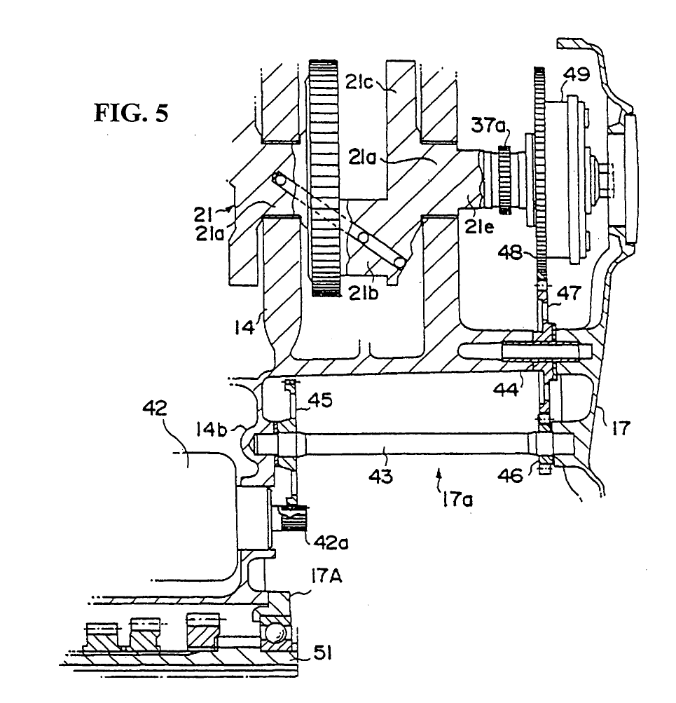

As shown in FIG. 5, the upper case half 14 is integrally provided with a bracket 14b located toward the upper side (the rear side of the cylinder block 12) from the vicinity of the support portion for supporting the third journal 21a. The right side surface of this bracket 14b is covered with the right cover 17, and an extension portion of the right accessory chamber 17a is formed on the right side of the bracket 14b.

Referring also to FIG. 2, a starter motor 42 is externally mounted to the left side surface of the bracket 14b, with a spindle directed in the left-right direction, and the spindle of the starter motor 42 is contained in the extension portion of the right accessory chamber 17a. A starting speed reduction mechanism for transmitting the driving force of the starter motor 42 to the crankshaft 21 is contained in the right accessory chamber 17a inclusive of the extension portion. The starting speed reduction mechanism includes a first starting idle shaft 43 supported by the right cover 17 and the bracket 14b and rotatably contained in the extension portion of the right accessory chamber 17a, a second starting idle shaft 44 provided at an aligned portion of the upper case half 14 and the right cover 16, a pinion 42a provided on the spindle of the starter motor 42, a first starting gear 45 meshed with the pinion 42a and connected to a left end portion of the first starting idle shaft 43, a second starting gear 46 connected to a right end portion of the first starting idle shaft 43, a third starting gear 47 meshed with the second starting gear 46 and provided on the second starting idle shaft 44, and a fourth starting gear 48 connected to a right end portion of the crankshaft 21 through a one-way clutch 49. The fourth starting gear 48 and the one-way clutch 49 are provided on the right side of the cam drive sprocket 37a.

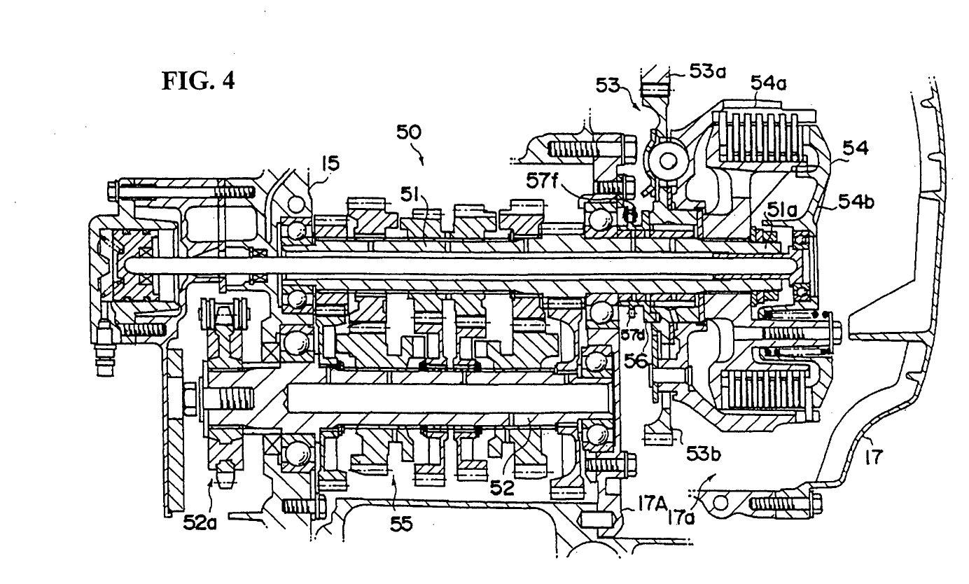

In addition, as shown in FIG. 4, a power transmission device 50 is contained in a rear portion of the crankcase 20. The power transmission device 50 includes a main shaft 51 located on the rear side of the crankshaft 21 and extending in the left-right direction, a counter shaft 52 located on the rear side of the main shaft 51 and extending in the left-right direction, a primary speed reduction gear train 53 for transmitting the rotation of the crankshaft 21 to the main shaft 51, a clutch mechanism 54 provided at an end portion of the main shaft 51 and operative to connect and disconnect the primary speed reduction gear train 53 to and from the main shaft 51, a plurality of speed change gear trains 55 provided between the main shaft 51 and a counter shaft 52, and a chain drive mechanism 52a provided between the counter shaft 52 and the rear wheel RW. By such a power transmission device 50, the rotation of the crankshaft 21 can be transmitted through the primary speed reduction gear train 53 to the main shaft 51, the rotation is then transmitted through one of the speed change gear trains 55 to the counter shaft 52, and is transmitted through the chain drive mechanism 52a to the rear wheel RW, whereby the motorcycle MC is enabled to run.

The main shaft 51 is rotatably supported on the split surface of the crankcase 20. Incidentally, right end portions of the main shaft 51 and the counter shaft 52 are rotatably supported on bearings contained in a bearing holder 17A. The bearing holder 17A is located relative to and fastened to both the case halves 14 and 15 by knock pins. Incidentally, the right accessory chamber 17a is formed on the right side of the bearing holder 17A, and a right end portion 51a of the main shaft 51 protrudes from the bearing, to be contained in the right accessory chamber 17a (FIG. 4).

The primary speed reduction gear train 53 is composed of a primary speed reduction drive gear 53a and a primary speed reduction driven gear 53b. The primary speed reduction drive gear 53a is provided on the outer periphery of a crank web formed on the right side of the fourth crank pin 21b. The primary speed reduction driven gear 53b is meshed with the primary speed reduction drive gear 53a, is provided to be rotatable relative to the right end portion 51a of the main shaft 51 and is contained in the right accessory chamber 17a. The clutch mechanism 54 is composed of an outer rotor 54a provided at the right end of the main shaft 51, is contained in the right accessory chamber 17a and is connected to the primary speed reduction driven gear 53b, and an inner rotor 54b is connected to the main shaft 51. When plates, provided respectively in the rotors 54a and 54b of the clutch mechanism 54, are engaged with each other, both the rotors 54a and 54b are rotated as one body, whereby the rotation of the primary speed reduction driven gear 53 can be transmitted to the main shaft 51. On the other hand, when the plates are disengaged, the transmission of power from the crankshaft 21 to the main shaft 51 is interrupted.

At the right end portion 51a of the main shaft 51, a collar 56 is provided between the primary speed reduction driven gear 53b and the right end face of the bearing holder 17A. The collar 56 rotates as one body with the primary speed reduction driven gear 53b. In addition, an oil pan 19 with a lubricating oil reserved therein is provided on the lower side of and is connected to the lower case half 15.

A trochoidal oil pump 57a is provided which supplies engine parts with the lubricating oil. The lubricating oil provided in the oil pan 19 is passed through a strainer 57g, also provided inside the oil pan 19, and is drawn through a suction pipe 57h to the trochoidal oil pump 57a. A drive shaft 57b for driving the trochoidal oil pump 57a is rotatably supported on a lower portion of the lower case half 15. The drive shaft 57b of the oil pump 57a is driven to rotate by an oil pump drive mechanism 57c provided inside the lower case half 15. The oil pump drive mechanism 57c includes an oil pump drive sprocket 57d formed as one body with the collar 56, an oil pump driven sprocket 57e provided on the drive shaft 57b of the oil pump 57a, and an oil pump chain 57f wrapped around both the sprockets 57d and 57e.

A secondary balancer shaft 58 is rotatably provided on the front lower side of the crankshaft 21. The secondary balancer shaft 58 rotates a balancer weight (not shown), provided thereon as one body therewith, when the rotation of the crankshaft 21 is transmitted thereto through a secondary balancer gear train 59, with the rotating speed doubled. The secondary balancer gear train 59 is composed of a secondary balancer drive gear 59a provided on the outer periphery of a crank web formed on the left side of the second crank pin 21b, and a secondary balancer driven gear 59b meshed with the secondary balancer drive gear 59a and connected to the secondary balancer shaft 58.

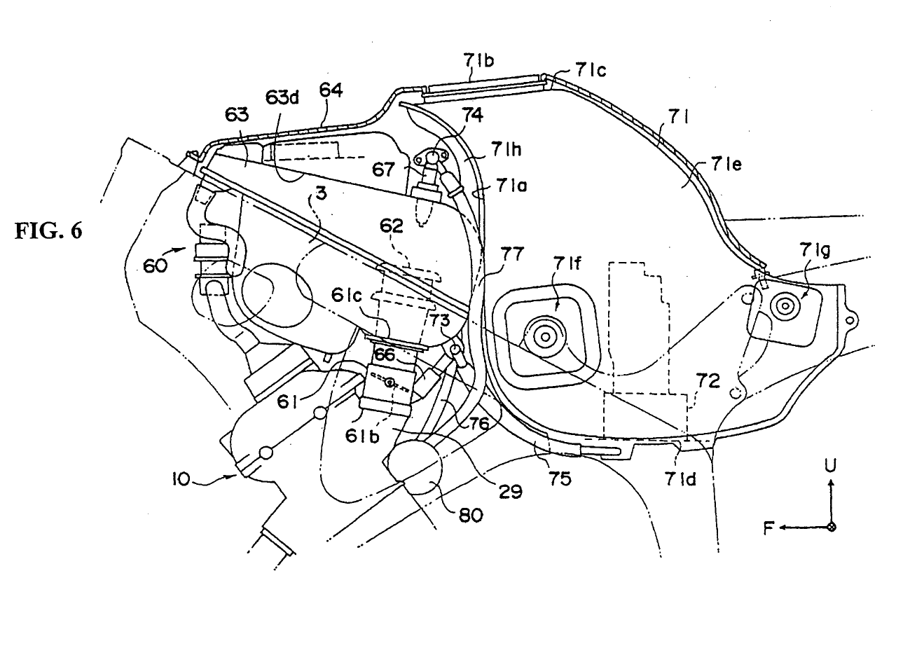

As above-mentioned, the intake air routing assembly 60 is connected to the intake port 29. As shown in FIGS. 2 and 6, the intake air routing assembly 60 includes throttle bodies 61 and an air cleaner chamber 63 connected to each other in this order from the outside opening of the intake port 29, and extends upward from a rear portion of the cylinder block 12.

The throttle bodies 61 are provided in correspondence with the four intake ports 29, are aligned in the left-right direction, and are each provided therein with an air passage 61a. In the inside of the throttle body 61, a throttle valve 61b for varying the opening according to an operation of an accelerator grip is provided. The downstream end (lower end) of the throttle body 61 is connected to the intake port 29, and the upstream end (upper end) of the throttle body 61 is connected to the air cleaner chamber 63.

The air cleaner chamber 63 has an upper-lower split structure in which a box-like upper chamber half 63a, which opens on the lower side thereof, and a box-like lower chamber half 63b, which opens on the upper side thereof, are fastened together. A chamber lower portion is covered with the main frame 3 as viewed from the side, and a chamber upper portion is provided to project above the upper side of the main frame 3. The upstream end of the throttle body 61 is attached to a lower wall 63c of the lower chamber half 63b. The lower wall 63c is provided with an air feed pipe 62 that is open on its upper and lower sides and communicates with the upstream end of the throttle body 61.

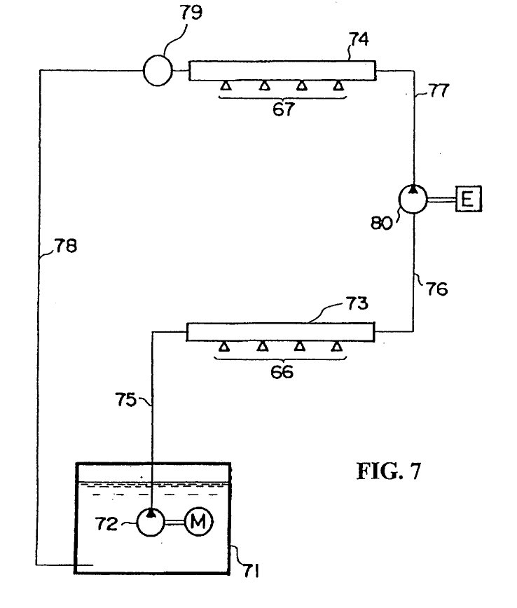

FIG. 7 is a block diagram of a fuel supply system of the engine 10. As shown in FIG. 7, a fuel supply system for the engine 10 includes: a fuel tank 71 for reserving a fuel; an electrically driven type electric fuel pump 72 provided in the inside of the fuel tank 71; a mechanically driven type fuel pump 80 driven by the engine 10; four downstream-side injectors 66 for injecting the fuel to the downstream side in the inside of the intake air routing assembly 60; four upstream-side injectors 67 for injecting the fuel to the upstream side in the inside of the intake air routing assembly 60; a first fuel supply passage 75 connected to the discharge port of the electric fuel pump 72; a first delivery pipe 73 connected to the downstream end of the first fuel supply passage 75 so as to lead the fuel discharged from the electric fuel pump 72 to the four downstream-side injectors 66; a second fuel supply passage 76 for connection between the downstream end of the first delivery pipe 73 and the suction port of the fuel pump 80; a third fuel supply passage 77 connected the discharge port of the fuel pump 80; a second delivery pipe 74 connected to the downstream end of the third fuel supply pipe 77 so as to lead the fuel discharged from the fuel pump 80 to the upstream-side injectors 67; and a return passage 78 connected to the downstream end of the second delivery pipe 74 so as to lead the fuel to the fuel tank 71.

In addition, a regulator is incorporated in the electric fuel pump 72, and the fuel regulated in pressure by the regulator is discharged into the first fuel supply passage 75, to be supplied to the downstream-side injectors 66. In addition, a pressure regulator 79 is interposed in the return passage 78, and the fuel regulated in pressure to a high pressure by the pressure regulator 79 is supplied to the upstream-side injectors 67.

As shown in FIGS. 1 and 6, the fuel tank 71 is provided on the rear side of the air cleaner chamber 63. The fuel tank 71 has a configuration in which a front wall 71a and a bottom plate 71d are each formed in a roughly flat plate-like shape, a top plate 71c is provided with an fuel feed port 71b, and the electric fuel pump 72 is provided at a bottom portion on the rear side in the interior of the fuel tank 71. Mount portions 71f and 71g are provided on the front and rear sides of left and right side plates 71e, and the fuel tank 71 is mounted on the vehicle body frame 1 through the mount portions 71f, 71g. As seen in FIG. 6, the upper surface of the fuel tank 71 is slightly above the upper surface of the air cleaner chamber 63. Only an upper portion of the front wall 71a extends forward while being curved to be concave on the lower side, providing an extension portion 71h that covers a rear upper portion of the air cleaner chamber 63. An upper half of the fuel tank 71 and an upper half of the air cleaner chamber 63, i.e., the portions projecting upwards from the vehicle body frame 1 are covered with a cover 64. The cover 64 is detachably attached to the vehicle body frame 1.

Each of the downstream-side injectors 66 and the upstream-side injectors 67 is provided with a fuel suction port at its upper end portion and with an injection port at its lower end portion. The downstream-side injectors 66 are mounted with their upper end portions inclined rearward from the rear side of the throttle body 61 and with their injection ports fronting on the downstream side of the throttle valve 61b, and are arrayed in the left-right direction. The upstream-side injectors 67 are externally attached to an upper wall 63d of the upper chamber half 63a, which is opposed to the lower wall 63c of the lower chamber half 63b. The upstream-side injectors 67 are each disposed on (are respectively aligned with) the axis of an air passage 61a in the throttle body 61, and are arrayed in the left-right direction with their injection ports opposed to the opening of the air feed pipe 62 fronting on the inside of the air cleaner chamber 63. With the upstream-side injectors 67 thus arranged on the axis, the injected fuel can be introduced into the intake air routing assembly more assuredly.

The fuel tank 71 is provided on the rear side of the air cleaner chamber 63 and on the upper side of the main frame 3. The first delivery pipe 73 extends in the left-right direction near upper end portions of the downstream-side injectors 66, and communicates with fuel suction ports of the downstream-side injectors 66. The second delivery pipe 74 extends in the left-right direction near upper end portions of the upstream-side injectors 67, and communicates with fuel suction ports of the upstream-side injectors 67.

A solenoid-driven type valve for opening and closing the injection port is incorporated in each of the downstream-side and upstream-side injectors 66 and 67. When an operation control signal is inputted from a controller (not shown), the valve is operated to open the injection port. In this instance, the fuel is injected from the downstream-side injector 66 to the downstream side of the throttle valve 61b in the interior of the throttle body 61, and the fuel is injected from the upstream-side injector 67 toward the opening of the air feed pipe 62.

The electric fuel pump 72 and the mechanically driven type fuel pump 80 are thus connected in series, and are used together by operating both of them. By doing so, the fuel injection pressure exerted on the upstream-side injectors 67 is set to be higher than the fuel injection pressure exerted on the downstream-side injectors 66. Therefore, although the upstream-side injector 67 is spaced a greater distance from the combustion chamber 26 than is the downstream-side injector 66, the time necessary for the fuel injected from the upstream-side injector 67 to reach the combustion chamber 26 is comparable to or shorter than that for the fuel injected from the downstream-side injector 66.

Thus, because the fuel injection pressure exerted on the upstream-side injectors 67 is set at a high pressure, the fuel can be injected in a short time; therefore, the variable range of the timing of injection of the fuel by the upstream-side injectors 67 can be broadened. In addition, a great effect can also be obtained in an engine provided with a system in which the times of opening the intake valve 35 and the exhaust valve 36 are variable (the system is referred to also as a variable valve timing system). In addition, the injection of the fuel at the high pressure promotes the atomization of the fuel, whereby volumetric efficiency and combustion efficiency are enhanced, promising a higher output.

Further, by injecting the fuel from the upstream-side and downstream-side injectors 66 and 67 at optimum fuel injection sharing ratios according to the load on the engine 10 (for example, the opening of the throttle valve 61b), a further enhancement of the output of the engine 10 is promised. Here, the fuel injection sharing ratio means the ratio of the amount of the fuel injected from the upstream-side injector 67 (or the downstream-side injector 66) to the whole amount of the fuel supplied into the combustion chamber 26.

To be more specific, by setting the fuel injection sharing ratio of the upstream-side injector 67 to be higher as the load on the engine 10 is increased, a higher output can be obtained. As a method of setting the fuel injection sharing ratios, there may be considered a method in which the fuel injection sharing ratio of the upstream-side injector 67 is set to 0% in a low-load region (e.g., an opening of the throttle valve 61b of 0 to 30%), the fuel injection sharing ratio of the upstream-side injector 67 is simply increased from 0% to 100% in proportion to an increase in load in a medium-load region (e.g., an opening of the throttle valve 61b of 30 to 80%), and the fuel injection sharing ratio of the upstream-side injector 67 is set to 100% in a high-load region (e.g., an opening of the throttle valve 61b of 80 to 100%).

Thus, in the low-load range where the amount of the fuel to be supplied into the combustion chamber 26 is small, the fuel injection sharing ratio of the downstream-side injector 66 nearer to the combustion chamber 26 is set higher, whereby fuel supply with a high response performance can be achieved; on the other hand, in the high-load range, the fuel injection sharing ratio of the upstream-side injector 67 higher in volumetric efficiency and combustion efficiency is set higher, whereby a high output can be displayed.

Furthermore, the downstream-side and upstream-side injectors 66 and 67 are disposed respectively on the downstream side and the upstream side relative to the throttle valve 61b. Therefore, in the low-load region, the fuel injected from the downstream-side injector 66 is supplied into the combustion chamber 26 without being hampered by the throttle valve 61b. In addition, in the high-load region, the opening of the throttle valve 61b is large, so that the fuel injected from the upstream-side injector 67 is supplied into the combustion chamber 26 naturally without being hampered by the throttle valve 61b.

Thus, since the electric fuel pump 72 and the mechanically driven type fuel pump 80 are connected in series with the upstream-side injector 67, utilization of the pressure of the electric fuel pump 72 as a preliminary pressure for the fuel pump 80 makes it possible to supply the fuel at a high pressure which is as high as several tens of times the ordinary pressure.

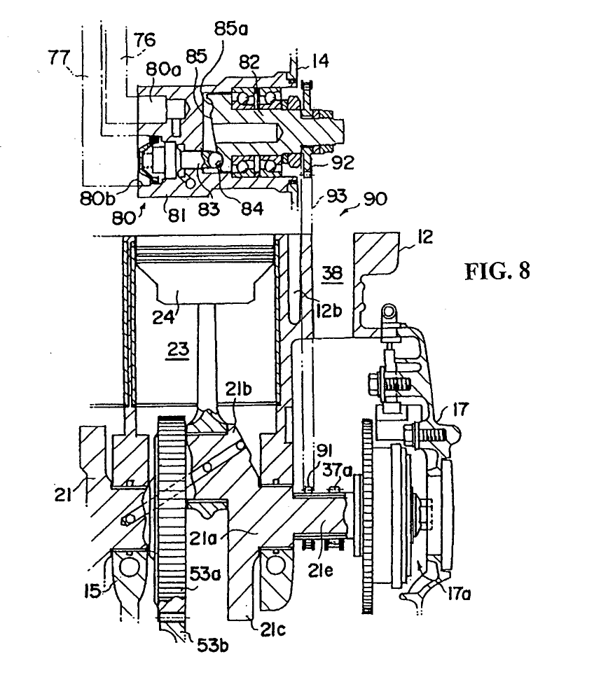

Now, the fuel pump 80 of the first embodiment will be described below referring to FIG. 8. The fuel pump 80 is a plunger type pump in which a rotating motion is converted by a cam into a reciprocating rectilinear motion of a plunger, and, hence, the plunger is reciprocated, thereby drawing in and discharging the fuel.

The fuel pump 80 includes a pump body 81 and a pump drive shaft 82 rotatably supported inside the pump body 81. The fuel pump 80 is provided with a swash plate cam surface 85 by cutting a left end face of the pump drive shaft 82 at a slant, and the plunger 83 is reciprocally contained in the inside of a plunger containing part formed inside the pump body 81 so as to extend in the axial direction of the pump drive shaft. The pump body 81 is provided with a suction port 80a to which the downstream end of the second fuel supply passage 76 is connected, and with a discharge port 80b to which the upstream end of the third fuel supply passage 77 is connected. Both the suction port 80a and the discharge port 80b communicate with the plunger containing part. The plunger 83 is urged by a spring incorporated therein, so as to maintain a condition where a ball member 84 that is attached to an end portion of the plunger 83 abuts on the swash plate cam surface 85 possessed by the pump drive shaft 82. The swash plate surface 85 is provided with a fitting groove 85a for stabilizing the abutment of the ball member 84 thereon, the fitting groove 85a extending in the circumferential direction.

In the fuel pump 80 as above, when the pump drive shaft 82 is rotated, the action of the swash plate cam surface 85 causes the plunger 83 to reciprocate inside the plunger containing part, with the ball member 84 kept in abutment on the swash plate cam surface 85. When the plunger 83 is moved downward (rightward), the fuel is drawn in from the second fuel supply passage 76 into the inside of the plunger containing part, and, when the plunger 83 is moved upward (leftward), the fuel is fed under pressure from the inside of the plunger containing part into the third fuel supply passage 77.

As shown in FIGS. 2 and 8, the pump body 81 is externally attached to the left side surface of the bracket 14b of the upper case half 14, at a position on the front upper side of the starter motor 42, and fixed in situ by a fixing means such as bolts. A right end portion of the pump drive shaft 82 is contained in an extension portion of the right accessory chamber 17a. This ensures that the fuel pump 80 is disposed on the upper side of the crankcase 21 and on the rear upper side of the cylinder block 12. In addition, the fuel pump 80 as a whole is contained in the inside space of the vehicle body frame 1, and an upper half portion thereof is covered with the reinforcement frames 5.

The pump drive shaft 82 is driven to rotate by the transmission of the rotation thereto from the crankshaft 21 through a pump drive mechanism 90. The pump drive mechanism 90 includes a pump drive sprocket 91 and a pump driven sprocket. The pump drive sprocket is connected to the left side of the cam drive sprocket 37a at a right end portion of the crankshaft 21. The pump driven sprocket 92 is connected to a right end portion of the pump drive shaft 82, and a pump chain 93 is wrapped around both the sprockets 91, 92, and transmits the rotation of the crankshaft 21 to the pump drive shaft 82 through speed reduction. Here, the pump chain 93 is disposed astride the first starting idle shaft 43 so that it does not interfere with the starting speed reduction mechanism inclusive of other gears 45 to 48.

In the engine 10 configured as above the exhaust pipe 65 is provided to extend downwardly on the front side of the engine 10 from a front portion of the cylinder block 12, the intake air routing assembly 60 is provided to extend upwards from a rear portion of the cylinder block 12, the upstream-side and downstream-side injectors 66 and 67 are attached to the intake air routing assembly 60, and the fuel pump 80 is provided on the upper side of the crankcase 20 and on the rear upper side of the cylinder block 12. As a result, since the fuel pump 80 is provided at a position spaced from the exhaust pipe 65, which is brought to a high temperature attendant on the operation of the engine 10, the thermal influence on the fuel pump 80 is reduced, the possibility of percolation or the like is lowered, and the heat insulation structure for the fuel pump 80 can be simplified. In addition, since the fuel pump 80 is provided at a position near the intake air routing assembly 60 and the injectors 66 and 67, the second and third fuel supply passages 76 and 77 can be made shorter, whereby a reduction in the pump drive loss can be obtained. This makes it possible to reduce the size of the fuel pump 80 and to reduce the overall weight of the engine 10.

In addition, in providing the pump drive mechanism 90, the pump drive sprocket 91 is provided in the dead space formed by the offset of the cam drive sprocket 37a. Therefore, in configuring the pump drive mechanism so as to pick up power directly from the crankshaft 21, the pump drive mechanism can be provided without enlarging the crankshaft 21 in size in the axial direction.

Further, since the fuel pump 80 is covered with the reinforcement frames 5, it is unnecessary to specially mount a protective member, so that the number of component parts of the fuel pump 80 is reduced, the durability of the fuel pump 80 is thereby enhanced, and a reduction in weight thereof is obtained. Further, the pump drive mechanism 90, with the reduced rotation of the crankshaft 21, sets the capacity of the fuel pump 80 larger, whereby a reduction in the pump drive loss is obtained.

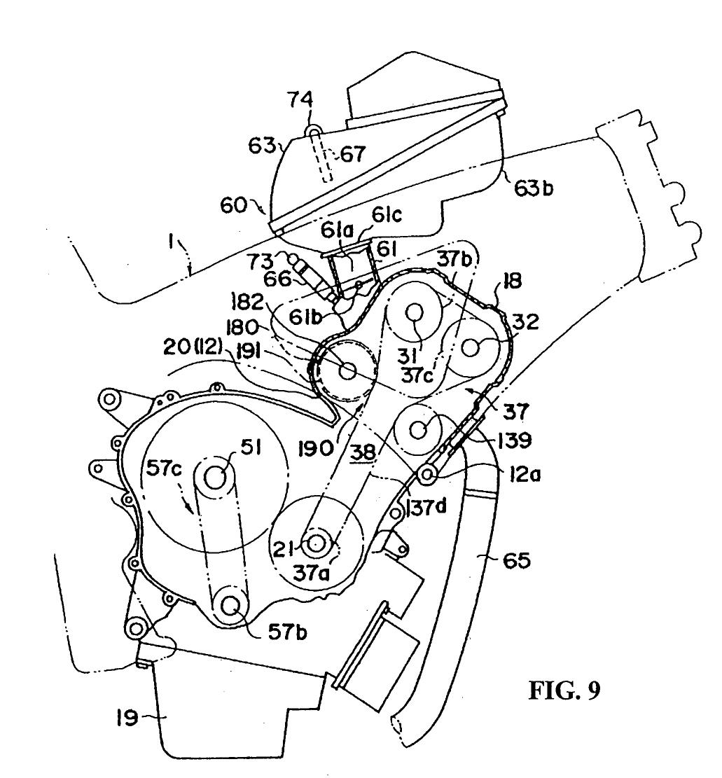

A fuel pump 180 according to a second embodiment of the invention will now be described with reference to FIG. 9. In the second embodiment, the basic structure of the engine 10 and the vehicle body frame 1 are the same as in the first embodiment; therefore, the same members as those in the first embodiment above will be denoted by the same symbols as used above, and descriptions of the same members will be omitted.

In the second embodiment, a cam chain 137d constituting a cam drive mechanism 37 is a link type chain such that sprockets can be engaged therewith from the inner side and from the outer side. In addition, the chain tensioner 39, provided in the first embodiment so as to press the cam chain 37d from the rear outer side, is omitted in this embodiment, and a fuel pump 180 is provided in the space generated due to the omission. Incidentally, a chain tensioner 139 in this embodiment is so provided as to press the cam chain 137d from the front outer side.

The fuel pump 180 in the second embodiment is configured in the same manner as in the first embodiment, i.e., it is so configured that a plunger is reciprocated in the axial direction of a pump drive shaft 182, whereby the fuel pump 180 can be configured to be compact as whole in the radial direction.

A pump body is externally attached to left walls of a cylinder block 12 and a cylinder head 13 which cooperate to form a chain chamber 38. As above-mentioned, this space is the space utilized for providing the chain tensioner 39 in the first embodiment. Incidentally, a right end portion of the pump drive shaft 182 is contained in the chain chamber 38.

A pump drive mechanism 190 for transmitting rotation to the pump drive shaft 182 includes the cam chain 137d, and a pump sprocket 191 connected to the right end portion of the pump drive shaft 182 and engaged with the cam chain 137d from the rear outer side. The pump sprocket 191 is contained in the chain chamber 38.

In the second embodiment, as in the first embodiment, the fuel pump 180 is provided on the rear side of the cylinder block 12 (on the upper side of the crankcase 20), which makes it possible to simplify the heat insulation structure for the fuel pump 180 and to reduce the pump drive loss.

In addition, while the fuel pump 80 is provided at the bracket 14b possessed by the crankcase 20 in the first embodiment above, in this embodiment the fuel pump 180 is provided bridgingly between an upper end portion of the cylinder block 12 and a lower end portion of the cylinder head 11. As a result, the distances between the fuel pump 180 and the downstream-side and upstream-side injectors 66, 67 attached to the intake air routing assembly 60 connected to the cylinder head 13 are further shortened. Therefore, the second and third fuel supply passages 76, 77 are further shortened, whereby the working efficiency of the fuel pump is enhanced, and a simpler piping structure is obtained.

In addition, the pump drive mechanism 190 has a simple configuration composed only of the cam chain 137d already provided in the engine 10 and the pump sprocket 191 engaged with the cam chain 137d, which results in a smaller number of component parts and a lighter weight of the engine 10. Furthermore, the variations in rotation exerted on the cam chain 137d can be attenuated by utilizing the drive friction of the fuel pump 180, whereby an enhanced durability of the cam chain 137d is obtained. In addition, with the chain tensioner 139 provided on the front side, the fuel pump 180 is provided in a vacant space, whereby an enlargement of the engine 10 in size toward the rear side is avoided.

The cam chain 137d in the second embodiment is not limited to the link type chain, insofar as a sprocket can be engaged therewith also from the outer side; for example, a double-sided cog belt may also be adopted.

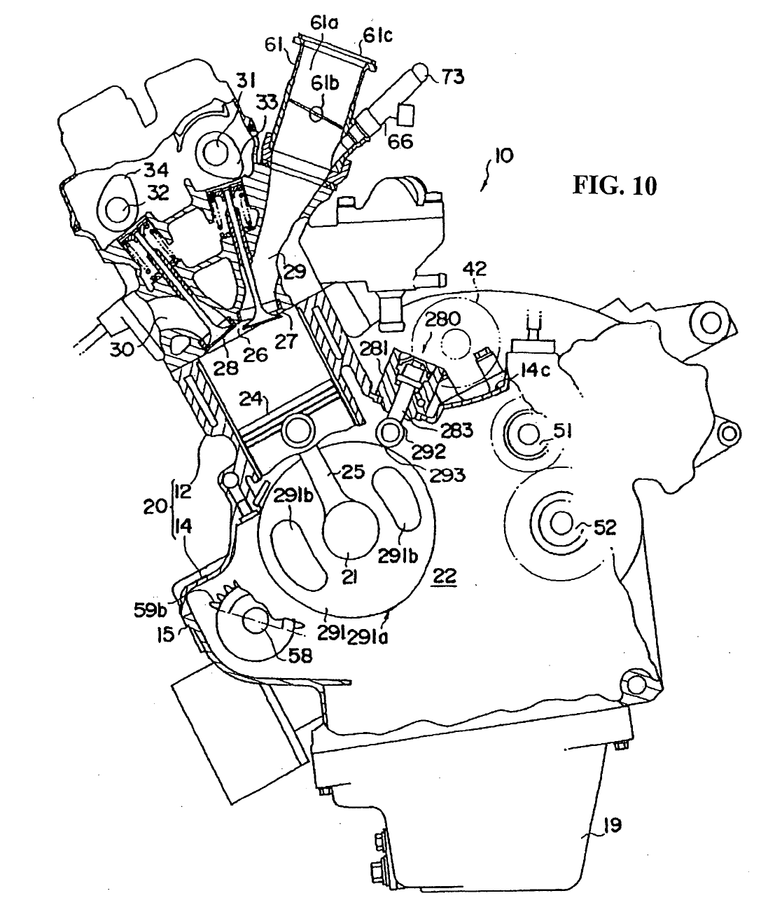

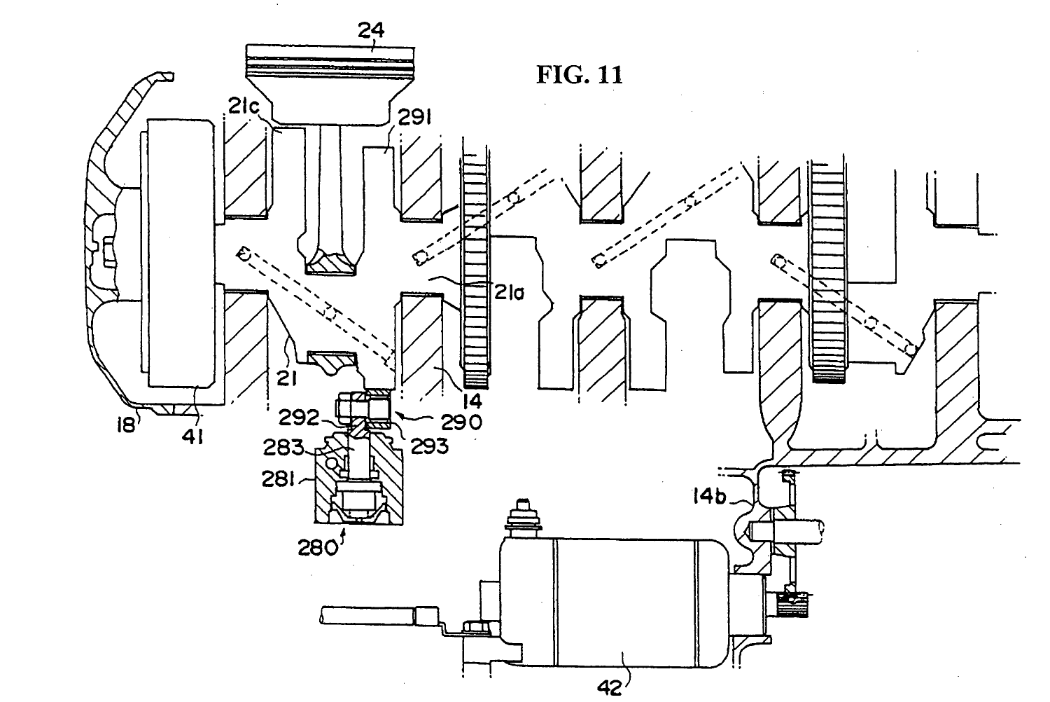

A fuel pump 280 according to a third embodiment will now be described with reference to FIGS. 10 and 11. In the third embodiment, like the second embodiment, the basic structure of the engine 10 and the vehicle body frame 1 are the same as in the first embodiment.

In the third embodiment, a cam 291 is integrally rotatably provided at the outer periphery of a crank web formed on the right side of a second crank pin 21b. The cam 291 is set so that a cam lobe peak 291a is located on the lower side when a second piston 24 is located at its bottom dead center, and so that the cam lobe peak 291a is located on the upper side when the second piston 24 is located at its top dead center. In addition, the side surfaces of the cam 291 are provided with through-holes 291b, 291b penetrating in the left-right direction, whereby a reduction in cam weight is obtained.

The fuel pump 280 in the third embodiment includes a pump body 281, and a plunger 283 contained in a plunger containing part formed in the pump body 281, but the pump drive shaft that was present in the first embodiment is omitted in the third embodiment.

The pump body 281 is attached, from the upper outer side, to an upper wall 14c of an upper case half 14 on the left side of a bracket 14b formed as one body with a crankcase 20, and overlaps with a starter motor 42 in side view. Here, the fuel pump 280 is provided in an area extending in a direction orthogonal to the axis of the crankshaft 21 from the cam 291 provided on the second crank pin 21b. Due to its placement in such an area, the fuel pump 280 does not interfere with other accessories such as the starter motor 42. Namely, the space in which the fuel pump 280 in this embodiment is provided has been a dead space in the first embodiment.

A pump drive mechanism 290 for the fuel pump 280 includes the above-mentioned cam 291, and a rod 292 extending rearwardly upwards in a direction roughly orthogonal to the crankshaft 21. A roller 293 is rotatably connected to one end portion of the rod 292, while the plunger 283 is connected to the other end portion of the rod 292, and the rod 292 is interlocked with the plunger 283. In the pump body 281, a spring is provided for urging the plunger 283 and the rod 292 toward the axis of the crankshaft 21, so as to maintain a condition where the roller 293 abuts on the cam 291. Incidentally, the position of abutment of the roller 293 and the cam 291 is set on the outside of a connecting rod locus.

When the crankshaft 21 is rotated, the action of the cam 291 brings the rod 292, and the plunger 283 connected to the rod 292, into reciprocating motion, whereby fuel drawn in from a second fuel supply passage 76 is fed under pressure into a third fuel supply passage 77. The cam lobe is formed so that the rod 292 and the plunger 283 reciprocate once during one revolution of the crankshaft 21.

In the third embodiment, the fuel pump 280 is provided on the upper side of the crankcase 20 and on the rear side of the cylinder block 12, so that it is possible to simplify the heat insulation structure for the fuel pump 280 and to reduce the pump drive loss.

In addition, the pump drive mechanism 290 has a simple configuration in which the pump drive mechanism 290 is composed only of the cam 291 provided on the crankshaft 21, which is already provided in the engine 10, and the rod 292 abutting on the cam 291, and the reciprocating motion of the rod 292 is transmitted directly to the plunger 283. Therefore, a reduction in the weight of the engine 10 is obtained, a bearing structure for a pump drive shaft is omitted, and the fuel pump 280 is also simplified in structure.

In addition, in providing the cam 291 on a crank web 21c, the cam 291 is disposed at a position in left-right symmetry with the position of a primary speed reduction drive gear 53a, whereby the influence of the cam 291 on the balancing is reduced. Further, since the mechanism is configured such that the abutment of the cam 291 and the roller 293 occurs on the outside of the connecting rod locus, the fuel pump 280 can be operated stably, irrespective of the phase of the pistons 24.

In the third embodiment, by changing the shape of the cam lobe according to the number of cylinders and the like, the number of strokes of the rod 293 and the plunger 283 in relation to the number of revolutions of the crankshaft 21 can be modified as required, and the discharge timing of the fuel pump can be simply set and modified according to the characteristics of the vehicle and the capacity of the fuel pump.

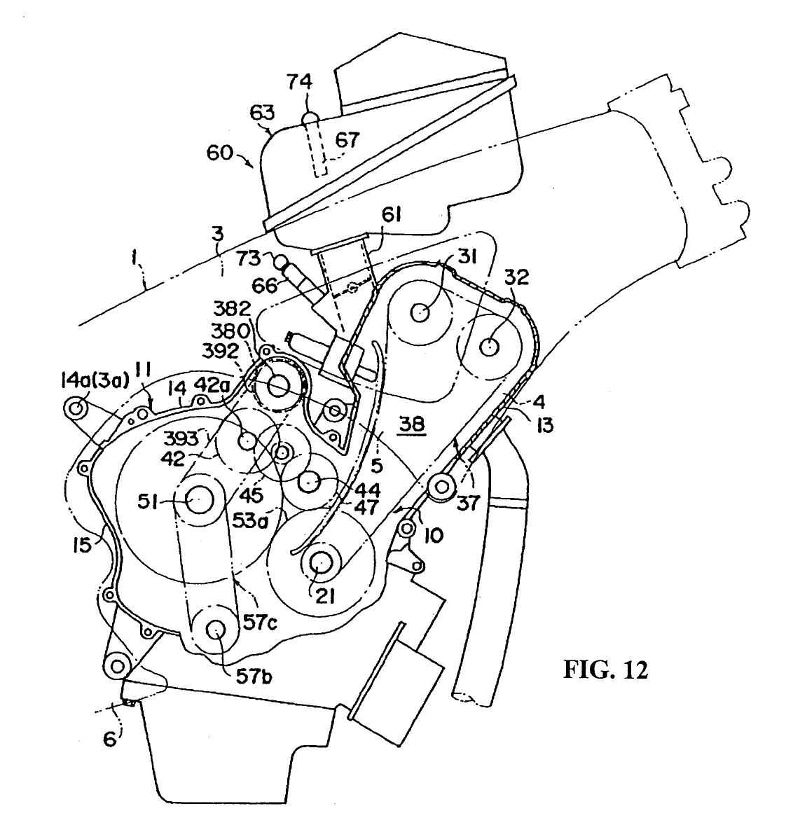

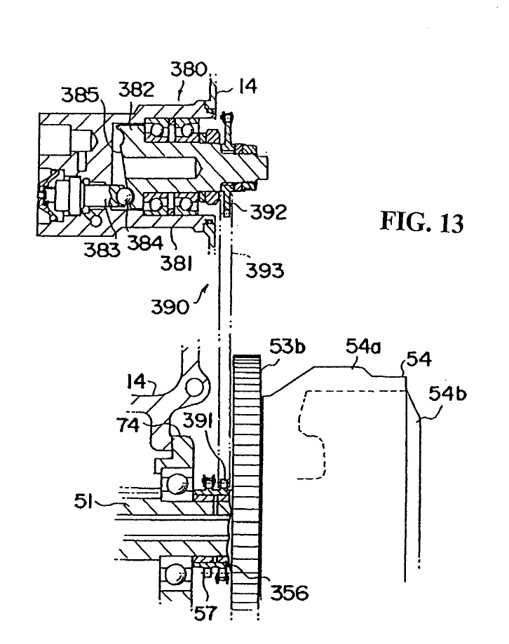

A fuel pump 380 according to a fourth embodiment of the invention will now be described with reference to FIGS. 12 and 13. In this embodiment, the fuel pump 380 is configured in the same manner as in the first embodiment, and is provided at the same position in side view as in the first embodiment, but the configuration of a pump drive mechanism 390 is different from that in the first embodiment. As shown in FIGS. 12 and 13, the pump drive mechanism 390 includes a pump drive sprocket 391 connected to a collar 356 provided on a main shaft 51, and a pump driven sprocket 392 provided at a right end portion of a pump drive shaft 382. In addition, a pump chain 393 is wrapped around both the sprockets 391 and 392, whereby the pump drive shaft 382 is rotated at the same speed as the main shaft 51.

The collar 356 in the fourth embodiment is slightly longer in the axial direction, as compared with that in the first embodiment, for the purpose of securing a space for arranging the pump drive sprocket 391. The pump drive sprocket 391 is provided on the right side of an oil pump drive sprocket 57d. Although the pump chain 393 overlaps with a starting speed reduction mechanism in side view, the pump chain 393 extends on the right side of a pinion 42a of a starter motor 42 and a first starting gear 45, and does not interfere with other members.

In the fourth embodiment, the fuel pump 380 is provided on the upper side of a crankcase 20 and on the rear side of a cylinder block 12, which makes it possible to simplify the heat insulation structure for the fuel pump 380 and to reduce the pump drive loss.

In addition, with the pump drive sprocket 391 provided on the collar 356 and rotated as one body with a primary speed reduction driven gear 53b of a power transmission device 50, a driving power can be transmitted with a speed reduction relative to a crankshaft 21, and the fuel pump 380 can be driven at a low rotating speed, so that a reduction in the pump drive loss is obtained. In addition, since the pump drive mechanism 390 is configured so as to pick up the power with speed reduction, it is unnecessary to reduce the rotating speed largely in the pump drive mechanism 390, so that the diameter of the pump driven sprocket 392 and the area occupied by the pump chain 393 is reduced.

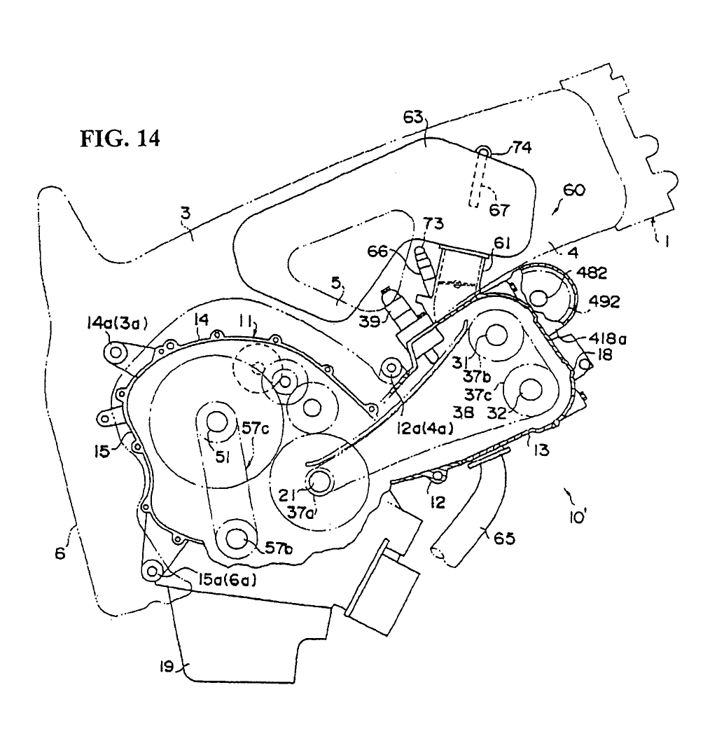

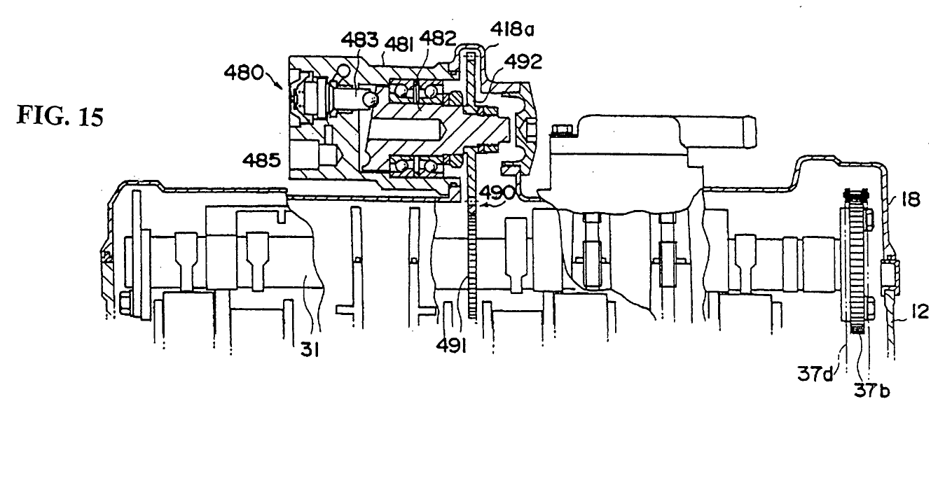

A fuel pump 480 according to a fifth embodiment of the present invention will now be described with reference to FIGS. 14 and 15. In this embodiment, the length of extension of hangers 4 constituting a vehicle body frame 1 toward the rear lower side is shorter, as compared with that in the first embodiment. In addition, a cylinder block 12 is provided in its rear upper end portion with a bolt hole 412a that is aligned with connection holes 4a formed in rear end portions of the hangers 4. Therefore, when an engine 10′ is fastened to the vehicle body frame 1, the axes of cylinder bores 23 are largely inclined forward, and upper surfaces of a cylinder head 13 and a cylinder block 12 are located on the lower side of the hangers 404, are directed forward and are exposed to the outside of the vehicle body frame 1.

Therefore, intake ports 29 extend upward from combustion chambers 26, exhaust ports 30 extend downward from the combustion chambers 26, and an intake air routing assembly 60 is provided to be connected to the intake ports 26 and to extend upward from an upper portion of the cylinder head 13. An exhaust pipe 65 is provided to be connected to the exhaust ports 30 and to extend downwardly from a lower portion of the cylinder head 13.

The fuel pump 480 in the fifth embodiment is configured in the same manner as in the above-described first embodiment, wherein a plunger 483 is reciprocated in the axial direction of a pump drive shaft 482, and the fuel pump 480 is configured to be compact in the radial direction. A pump body 481 is connected to a pump bracket 418a formed to project forward from a head cover 18.

A pump drive mechanism 490 in the fifth embodiment includes a drive gear 491 connected to a central portion in the left-right direction of an intake camshaft 31, and a driven gear 492 meshed with the drive gear 491 and connected to a right end portion of the pump drive shaft 482. The pump drive mechanism 490 is configured so as to transmit the rotation of the intake camshaft 31 to the pump drive shaft 482 while maintaining the same rotating speed.

In this embodiment, also, the fuel pump 480 is provided on the front upper side of the cylinder head 13, so that it is spaced away from the exhaust pipe 65 and is set close to downstream-side and upstream-side injectors 66 and 67 and the intake air routing assembly 60, whereby it is possible to simplify the heat insulation structure for the fuel pump 480 and to reduce the pump drive loss. Further, since the cylinder head 13 is exposed to the outside of the vehicle body frame 1 with the axes of the cylinder bores 23 being inclined forward, a running airflow is blown to the fuel pump 480 during operation of the vehicle. With the fuel pump 480 thus air-cooled, the operating efficiency of the fuel pump 480 is enhanced.

In addition, in this embodiment, the pump drive mechanism 490 is configured by use of the gear train. Therefore, the fuel pump 480 can be disposed closer to the intake camshaft 31, as compared with the case where the pump drive mechanism 490 is of a chain power transmission system. In addition, since the intake camshaft 31 is rotated with a speed reduction in relation to the crankshaft 21, it is unnecessary for the pump drive mechanism to function as a speed-reducing mechanism, so that the driven gear 492 can be made smaller in diameter. Further, the fuel pump has such a form that it can be made compact in the radial direction. Therefore, even though the pump body 481 is mounted on the outside of the head cover 18 as above-mentioned, the engine 10′, with the axes of the cylinder bores 23 inclined forward, is prevented from being enlarged in its length in the front-rear direction.

In addition, the fuel pump 480 can be mounted to the engine 10′ by a process in which the intake camshaft 31, with the drive gear 491 connected thereto, is mounted onto the cylinder head 13 and, thereafter, the pump body 481 containing the pump drive shaft 482 with the driven gear 492 connected thereto together with the plunger 483 is mounted onto the cylinder head 13. Therefore, ease of assembly is enhanced, as compared with the case of the chain power transmission system.

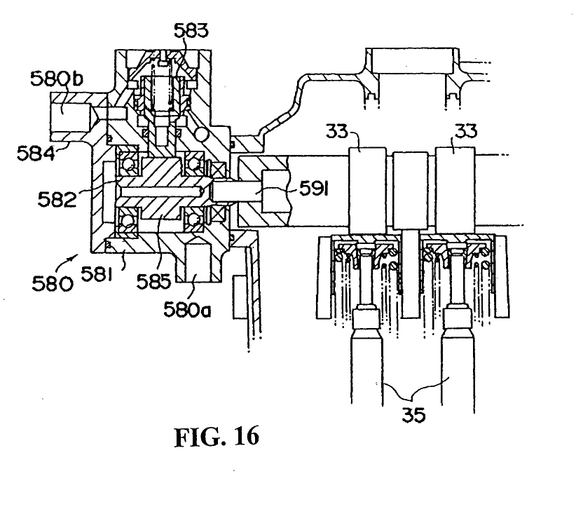

A fuel pump 580 according to a sixth embodiment of the present invention will now be described with reference to FIG. 16. In this embodiment, the basic structure of an engine 10′ and the structure of a vehicle body frame 1 are the same as those of the fifth embodiment.

The fuel pump 580 in this embodiment includes a pump body 581, a pump drive shaft 582 rotatably contained in the pump body 581, and a cam lobe 585 formed on the pump drive shaft 582 extending in a radial direction. In addition, a plunger 583 is contained in a plunger containing part extending inside the pump body 581 in a radial direction of the pump drive shaft 582, and a shaft cover 582 is attached to the pump body 581 after the mounting of the pump drive shaft 582. The pump body 581 is provided with a suction port 580a to which the downstream end of a second fuel supply passage 76 is connected, whereas the shaft cover 584 is provided with a discharge port 580b to which the upstream end of a third fuel supply passage 77 is connected, and both the suction port 580a and the discharge port 580b communicate with the plunger containing part. The plunger 583 is urged by a spring incorporated therein, whereby an end portion thereof is maintained in abutment on the cam lobe 585.

In the fuel pump 580 as above, when the pump drive shaft 582 is rotated, the action of the cam lobe 585 causes the plunger 583 to be reciprocated while keeping its end portion in abutment on the cam lobe 585. When the plunger 583 is moved downwards, a fuel fed from the second fuel supply passage 76 is drawn through the suction port 580a into the inside of the plunger containing part, and, when the plunger 583 is moved upwards, the fuel is fed under pressure through the discharge port 580b into the third fuel supply passage 77. In this form of fuel pump, the plunger 583 reciprocates in a radial direction of the pump drive shaft 582, so that the fuel pump 580 is configured to be compact as a whole in the axial direction.

In the fuel pump 580, the pump body 581 is externally mounted to right side surfaces of a cylinder head 13 and a head cover 18, and the pump drive shaft 582 is disposed coaxially with an intake camshaft 31. The pump drive shaft 582 is connected to the intake camshaft 31 through a joint 591. Therefore, when the intake camshaft 31 is rotated, the pump drive shaft 582 is rotated as one body with the intake camshaft 31.

In the sixth embodiment, the fuel pump 580 is provided on the front upper side of the cylinder head 13, so that it is possible to simplify the heat insulation structure for the fuel pump 580 and to reduce the pump drive loss. In addition, a running airflow is blown to the fuel pump 580 during operation of the vehicle, whereby the operating performance of the fuel pump 580 is enhanced. In addition, since the fuel pump 580 is configured to be compact in the radial direction, at the time of externally mounting the fuel pump 580 to a side surface of the cylinder head 13, the amount of its projection from the side surface is reduced, so that the arrangement of the fuel pump 580 does not hinder the configuration of the engine 10′ in a compact form.

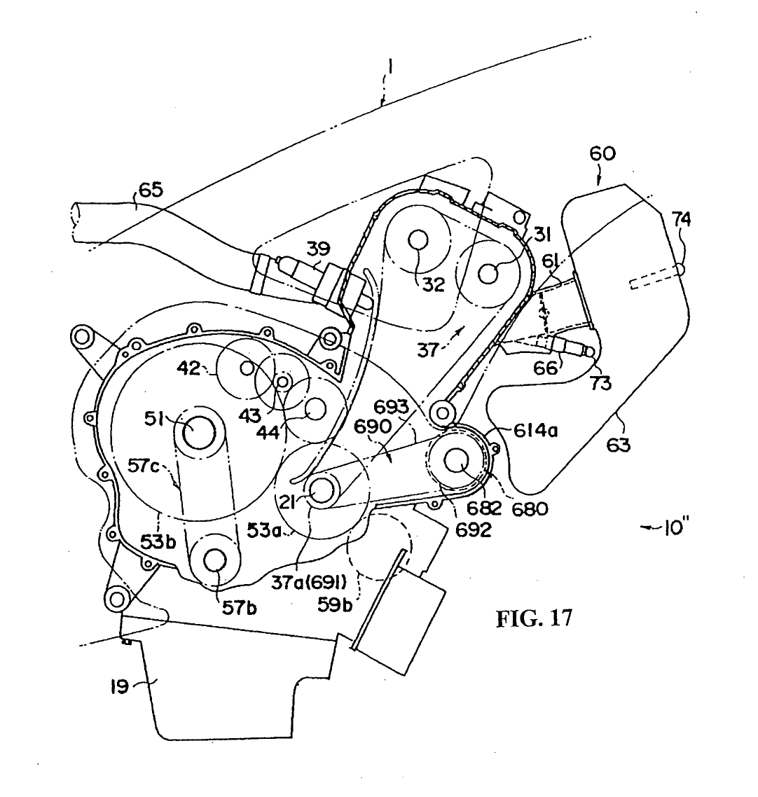

A fuel pump 680 according to a seventh embodiment of the present invention will now be described below referring to FIG. 17. In this embodiment, the structure of a vehicle body frame 1 is the same as in the first embodiment.

An engine 10″ in this embodiment has a structure in which intake ports are formed to extend forwardly from combustion chambers in the inside of the cylinder head 13, and exhaust ports are formed to extend rearwardly from the combustion chambers in the inside of the cylinder head 13. Therefore, as shown in the figure, an intake air routing assembly 60 extends forward from a front portion of the cylinder head 13, and an air cleaner chamber 63 is disposed on the front side of the cylinder head 13. In addition, an exhaust pipe 65 extends toward the rear upper side from a rear portion of the cylinder head 13.

In addition, the fuel pump 680 in this embodiment is configured in the same manner as in the first embodiment above, wherein a plunger reciprocates in the axial direction of a pump drive shaft 682, so that the fuel pump 680 is compact in the radial direction.

A pump body is externally mounted onto a left side surface of a pump bracket 614a formed as one body with an upper case half 14 so as to project toward the front side of the upper case half 14. A right cover 17 is mounted so as to cover the right side of the pump bracket 614a, and a right end portion of the pump drive shaft 682 is contained in the inside of a right accessory chamber 17a.

A pump drive mechanism 690 transmits rotation to the pump drive shaft 682, and includes a pump drive sprocket 691 provided on the right side of a cam drive sprocket 37a in the same manner as in the first embodiment, a pump driven sprocket 692 connected to a right end portion of the pump drive shaft 682, and a pump chain 693 wrapped around both the sprockets 691, 692. The pump drive mechanism 690 transmits the rotation of a crankshaft 21 to the pump drive shaft 682 with speed reduction.

In the seventh embodiment, the intake air routing assembly 60 is provided to extend forwardly from a front portion of the cylinder head 13, the exhaust pipe 65 is provided to extend rearwardly from a rear portion of the cylinder head 13, and the fuel pump 680 is provided on the front side of a crankcase 20 and a cylinder block 12. Therefore, the fuel pump 680 is spaced away from the exhaust pipe 65 and set closer to downstream-side and upstream-side injectors 66 and 67 and the intake air routing assembly 60, so that it is possible to simplify the heat insulation structure for the fuel pump 680 and to reduce the pump drive loss. In addition, since the fuel pump 680 is exposed from the vehicle body frame 1, a running airflow is blown to the fuel pump 680 during operation of the vehicle. With the fuel pump 680 thus air-cooled, the operating performance of the fuel pump 680 is enhanced. Furthermore, since the front side of the fuel pump 680 is covered with a lower end portion of the air cleaner chamber 63, the front side of the fuel pump 680 is protected, so that a protective structure for exclusive use is simplified. In addition, since the fuel pump 680 is disposed in a dead space between the crankcase 20 and the air cleaner chamber 63, effective utilization of space is achieved, and a smaller overall engine size is realized.

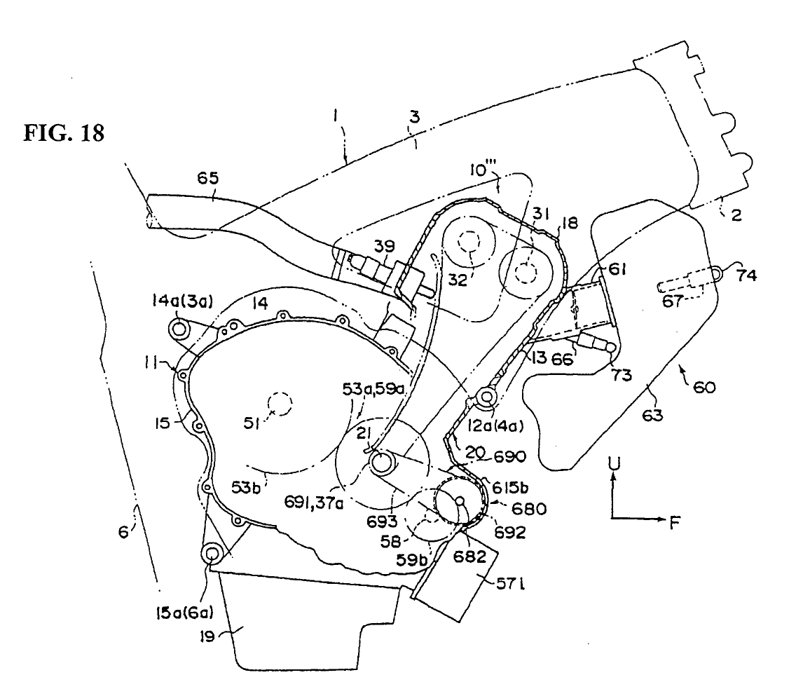

FIG. 18 shows a modified embodiment of the seventh embodiment. Herein, a balancer shaft 58 is provided so that power is transmitted thereto through a balancer gear train 59 provided at a second crank pin 21b of a crankshaft 21, and the balancer shaft 58 is provided to extend further leftwards from there. Therefore, in the first to sixth embodiments above, a dead space has been formed on the right side of the balancer shaft 58. In this embodiment, although a fuel pump 680 overlaps with the balancer shaft 58 in side view, the fuel pump 680 is disposed in the dead space.

In addition, a pump body is externally mounted to a left side surface of a pump bracket 615b formed as one body with a lower case half 15 so as to project forward, a right cover 17 is so mounted as to cover the right side of the pump bracket 615b, and a right end portion of a pump drive shaft 682 is contained in the inside of a right accessory chamber 17a.

In this configuration, also, it is possible to simplify the heat insulation structure for the fuel pump 680 and to reduce the pump drive loss. In addition, since the fuel pump 680 is exposed from a vehicle body frame 1, a running airflow is blown to the fuel pump 680 during operation of the vehicle, whereby air-cooling performance is enhanced.

Further, while the fuel pump in the seventh embodiment has been configured by forming the pump drive mechanism in the same manner as in the first embodiment, the fuel pump and the pump drive mechanism may be configured in the same manner as in the second embodiment, the sprocket may be engaged with the cam chain from the front outer side, and the fuel pump may be disposed on the front side of the cylinder block. Furthermore, the fuel pump and the pump drive mechanism may be configured in the same manner as in the third embodiment, and the valve body of the fuel pump may be mounted from the outside of a front wall of the crankcase. In any of these modified examples, it is possible to simplify the heat insulation structure for the fuel pump and to reduce the pump drive loss, in the same manner as in the seventh embodiment.

Thus, in all of the embodiments described above, the direction in which the intake air routing assembly 60 extends and the direction in which the exhaust pipe 65 extends are substantially opposite (with an angle therebetween of about 180 degrees), and the injectors 66 and 67 for injecting the fuel into the intake air routing assembly 60 are provided. Since the fuel pump is provided on the side on which the intake air routing assembly 60 extends, with respect to the cylinder block 12 and the cylinder head 13, the fuel pump is spaced away from the exhaust pipe 65 and is set close to the intake air routing assembly 60, so that the thermal influence on the fuel pump is lessened, the fuel supply passages are shortened, and it is possible to simplify the heat insulation structure for the fuel pump and to reduce the pump drive loss.

While a working example of the present invention has been described above, the present invention is not limited to the working example described above, but various design alterations may be carried out without departing from the present invention as set forth in the claims.

What is claimed is:

1. An internal combustion engine comprising:
a crankcase having a hollow crank chamber formed therein;
a crankshaft rotatably supported on the crankcase;
a cylinder block having a cylinder chamber provided therein, said cylinder block provided on an upper side of, and connected to said crankcase;
a piston slidably disposed in the cylinder chamber and operatively connected to said crankshaft;
a cylinder head disposed on an upper side of, and connected to, said cylinder block so as to cover said cylinder chamber, the cylinder head comprising an intake port extending in a first direction toward a first side of said cylinder block, and an exhaust port extending in a second direction that is substantially opposed to the first direction, wherein said intake port and said exhaust port are respectively capable of selectively communicating with a combustion chamber disposed in said cylinder chamber between said cylinder head and said piston;
an intake air routing assembly connected to said intake port;
a first fuel injector provided on said intake air routing assembly for injecting fuel into said intake air routing assembly during engine operation; and
a fuel pump provided on the first side of said cylinder block, and on an upper portion of said crankcase, wherein said fuel pump is mechanically driven and supplies fuel to said fuel injector during engine operation.

2. The internal combustion engine as set forth in claim 1, wherein the fuel pump further comprises a fuel pump drive shaft, and wherein the engine further comprises:
a camshaft rotatably supported on said cylinder head;
a cam drive mechanism contained in a timing chamber formed inside lateral portions of said cylinder block and said cylinder head, respectively, the cam drive mechanism adapted to transmit rotation of said crankshaft to said camshaft during engine operation, and
a pump drive mechanism for transmitting the rotation of said crankshaft to the fuel pump drive shaft; wherein:
one end part of the crankshaft projects outside of the crankcase,
the cam drive mechanism comprises a drive element, the drive element disposed on the one end part of the crankshaft, and
said pump drive mechanism comprises:
a pump drive sprocket provided at said one end part of said crankshaft and located on an axially inner portion thereof relative to said drive element of said cam drive mechanism;
a pump driven sprocket provided on said drive shaft of said fuel pump; and
a flexible belt wrapped around and interconnecting said pump drive sprocket and said pump driven sprocket.

3. The internal combustion engine as set forth in claim 1, wherein said intake air routing assembly comprises:
a throttle body, one end of the throttle body being operatively connected to the intake port;
an air feed pipe, the air feed pipe extending from another end of the throttle body, and
an air cleaner housing having an air cleaner chamber formed therein,
wherein a portion of the air feed pipe is enclosed within the air cleaner chamber, and wherein the first fuel injector is mounted to an upper surface of the air cleaner housing and is oriented to direct fuel towards an inlet of the air feed pipe.

4. The internal combustion engine as set forth in claim 3, wherein said engine further comprises a second fuel injector mounted on the throttle body, the second fuel injector configured to inject fuel directly into the throttle body during engine operation.

5. The internal combustion engine as set forth in claim 1, wherein the fuel pump comprises:
a pump body, the pump body having an opening formed therein, an inlet port permitting communication between a fuel input passage and the opening, and a discharge port permitting communication between a fuel discharge passage and the opening;
a pump drive shaft rotatably supported inside the pump body, a first end of the pump drive shaft comprising a cam surface; and
a plunger mounted in an opening of the pump body so as to reciprocate with respect to the pump body, the plunger extending from the pump body, the plunger being biased to abut against the cam surface,
wherein the fuel pump is configured such that rotary motion of the pump drive shaft results in reciprocating rectilinear motion of the plunger, whereby fuel is drawn in through the inlet port and discharged from the discharge port.

6. The internal combustion engine as set forth in claim 5, wherein an axis of the plunger is substantially parallel to an axis of the pump drive shaft.

7. The internal combustion engine as set forth in claim 5, wherein the fuel pump further comprises a pump driven sprocket connected to a second end of the pump drive shaft, and wherein the pump driven sprocket is operatively connected to the crankshaft, whereby the fuel pump is mechanically driven by rotation of the crankshaft.

8. The internal combustion engine as set forth in claim 1, the fuel pump further comprising a fuel pump drive shaft and a pump sprocket mounted on the fuel pump drive shaft, and the engine further comprising:
a camshaft rotatably supported on said cylinder head,
a cam drive mechanism contained in a timing chamber formed inside lateral portions of said cylinder block and said cylinder head, the cam drive mechanism configured to transmit rotation of said crankshaft to said camshaft during engine operation, and
a pump drive mechanism for transmitting the rotation of said crankshaft to the fuel pump drive shaft; wherein
said cam drive mechanism comprises:
a cam drive sprocket provided on said crankshaft;
a cam driven sprocket provided on said camshaft, and
a cam timing belt wrapped around and interconnecting said cam drive sprocket and said cam driven sprocket;
wherein said pump drive mechanism obtains a driving force from the pump sprocket, and the pump sprocket is driven by said cam timing belt.

9. The internal combustion engine as set forth in claim 1, the engine further comprising:
a cam formed integrally with an outer periphery of a web of said crankshaft; and
a pump drive mechanism for transmitting rotation of said crankshaft to said fuel pump to thereby drive said fuel pump, wherein
said pump drive mechanism comprises a rod abutting on said cam and extending in a direction orthogonal to the axis of said crankshaft.

10. The internal combustion engine as set forth in claim 1, the fuel pump further comprising a fuel pump drive shaft, and the engine further comprising:
a power transmission device for transmitting rotation of said crankshaft to a drive train component operatively connected to a wheel or wheels; and
a pump drive mechanism, the pump drive mechanism transmitting the rotation of said crankshaft to the fuel pump drive shaft during engine operation, wherein
said power transmission device comprises:
a main shaft disposed in parallel to said crankshaft;
a primary speed reduction transmission path that transmits the rotation of said crankshaft to said main shaft through speed reduction; and
a clutch mechanism provided on said main shaft so as to connect and disconnect said primary speed reduction transmission path and the crankshaft,
wherein said primary speed reduction transmission path comprises:
a primary speed reduction drive element connected to said crankshaft; and
a primary speed reduction driven element rotated with a speed reduction relative to said primary speed reduction drive element, the primary speed reduction driven element provided so as to rotate relative to said main shaft and connect to an upstream-side member of said clutch mechanism,
and wherein said pump drive mechanism comprises:
a pump drive sprocket which rotates integrally with said primary speed reduction driven element;
a pump driven sprocket provided on said drive shaft of said fuel pump; and
a flexible pump drive belt wrapped around and interconnecting said pump drive sprocket and said pump driven sprocket.

11. A vehicle comprising a vehicle frame, an internal combustion engine mounted on the vehicle and connected to the vehicle frame, and a fuel pump for supplying fuel to the engine, the engine comprising:
a crankcase having a crank chamber formed therein;
a crankshaft rotatably supported on the crankcase;
a piston operatively connected to the crankshaft;
a cylinder block disposed on said vehicle frame so as to be operatively exposed to air flow during vehicle operation, the cylinder block fixedly attached to said crankcase and comprising a cylinder chamber in which the piston is slidably disposed, with an axis of said cylinder chamber inclined toward a front side of the vehicle;
a cylinder head connected to said cylinder block so as to cover said cylinder chamber, the cylinder head disposed on said vehicle frame so as to be exposed to air flow during vehicle operation, the cylinder head provided with an intake port formed therein and extending toward a vehicle rear upper side and an exhaust port formed therein and extending toward a vehicle front lower side, said intake port and said exhaust port respectively capable of selectively communicating with a combustion chamber;
an intake air routing assembly connected to said intake port; and
a fuel injector provided on said intake air routing assembly for injecting fuel into said intake air routing assembly,
wherein said fuel pump is a mechanically driven fuel pump for supplying fuel to said fuel injector, and said fuel pump is provided on the vehicle front upper side of said cylinder head.

12. The vehicle as set forth in claim 11, wherein the fuel pump further comprises a fuel pump drive shaft, and the engine further comprises:
a camshaft rotatably supported on said cylinder head; and
a pump drive mechanism for transmitting rotation of said crankshaft to the fuel pump drive shaft, and
said pump drive mechanism comprises:
a pump drive gear provided on said camshaft; and
a pump driven gear provided on said fuel pump drive shaft, the pump driven gear intermeshed with said pump drive gear.

13. The internal combustion engine as set forth in claim 11, wherein the fuel pump comprises:
a pump body, the pump body including an opening formed therein, an inlet port permitting communication between with a fuel input passage and the opening, and a discharge port permitting communication between a fuel discharge passage and the opening;
a pump drive shaft rotatably supported inside the pump body, the pump drive shaft comprising a cam surface; and
a plunger mounted in an opening of the pump body so as to reciprocate with respect to the pump body, the plunger extending from the pump body, the plunger being biased to abut against the cam surface,
wherein the fuel pump is configured such that rotary motion of the pump drive shaft results in reciprocating rectilinear motion of the plunger, whereby fuel is drawn in the inlet port and discharged from the discharge port.

14. The internal combustion engine as set forth in claim 13, wherein an axis of the plunger is substantially parallel to an axis of the pump drive shaft.

15. The internal combustion engine as set forth in claim 13, wherein an axis of the plunger is substantially perpendicular to an axis of the pump drive shaft.

16. An internal combustion engine comprising:
a cylinder block provided with a cylinder chamber formed therein;
a cylinder head provided on the upper side of, and connected to, said cylinder block so as to cover said cylinder chamber, the cylinder head comprising an intake port and an exhaust port which communicate with a combustion chamber;
an intake air routing assembly connected to said intake port;
a fuel injector provided at said intake air routing assembly and injecting a fuel into the inside of said intake air routing assembly, and
a fuel pump for delivering fuel to the engine, said fuel pump disposed on a first side of said cylinder block, and is disposed below said intake gas pipe member;
wherein
said fuel pump is a mechanically driven type internal-combustion-engine fuel pump for supplying said fuel to said fuel injector;
said intake port is formed inside said cylinder head so as to extend in a first direction from said combustion chamber on said first side of said cylinder block, and said exhaust port is formed inside said cylinder head so as to extend in a second direction from said combustion chamber, the second direction being opposed to the first direction.
